(19) United States
(12) Patent Application Publication
(10) Pub. No.: US 2025/0158914 A1
(43) Pub. Date: May 15, 2025

(54) SYSTEMS AND METHODS FOR INTELLIGENTLY ROUTING DIGITAL ACTIVITY PROFILE DATA IN AN AUTOMATED SCHEDULED CASCADE

(71) Applicant: Word Merchant, Inc., Torrance, CA (US)

(72) Inventors: Alex Becker, Sherman Oaks, CA (US); Robert Simon, Manhattan Beach, CA (US); Matt Thelen, Los Angeles, CA (US); Brad Simon, Rossmoor, CA (US)

(73) Assignee: Word Merchant, Inc., Torrance, CA (US)

(21) Appl. No.: 18/943,316

(22) Filed: Nov. 11, 2024

Related U.S. Application Data
(60) Provisional application No. 63/547,980, filed on Nov. 9, 2023.

(51) Int. Cl. H04L 45/02; H04L 69/22

(52) U.S. Cl. CPC H04L 45/02; H04L 69/22

(57) ABSTRACT

A computer-implemented system, computer-implemented method, and computer-program product includes a dynamic data packet routing service receiving, via a network, one or more cascading parameters and inputs for constructing a cascading data packet and identifying a set of networked entity nodes arranged in a defined order, where the one or more cascading parameters includes routing sequence parameters and one or more temporal threshold parameters; configuring, by a microservice, the cascading data packet based on the one or more cascading parameters, where the configuring includes encoding for the cascading data packet a set of dynamic routing instructions based on the routing sequence parameters and a set of temporal thresholds based on the one or more temporal threshold parameters; storing, to a memory, the cascading data packet and the configuration of the cascading data packet; and transmitting the cascading data packet to a first networked entity node of the set.

### CROSS-REFERENCE TO RELATED APPLICATIONS

This application claims the benefit of U.S. Provisional Application No. 63/547,980, filed on 9 Nov. 2023, which is incorporated in its entirety by this reference.

### TECHNICAL FIELD

The inventions herein relate generally to the digital data routing field, and more specifically to a new and useful system and method for routing digital task data in the data routing field.

### BACKGROUND

In contemporary professional environments, the exchange of digital task or activity data is an integral part of operations for a wide spectrum of entities, encompassing individuals, organizations, and corporations alike. The managing and routing of such digital data is critical to facilitating communication, decision-making, and productivity. Due to the multitude and diversity of entities in such environments, such data is often unstructured and may not adhere to standardized format or schema, making it difficult to share at scale with a variety of different types of entities. Additionally, routing such data is often managed directly or manually by individual users, which can be difficult or impossible as such entity networks grow larger.

Therefore, there is a need in the digital data routing field to create improved systems and methods for intelligently and automatically managing the creation and routing of digital task or activity data in a network of entities. The embodiments of the present application described herein provide technical solutions that address, at least, the needs described above, as well as deficiencies of the state of the art.

### BRIEF SUMMARY OF THE EMBODIMENT(S)

This summary is not intended to identify only key or essential features of the described subject matter, nor is it intended to be used in isolation to determine the scope of the described subject matter. The subject matter should be understood by reference to appropriate portions of the entire specification of this patent, any or all drawings, and each claim.

A computer-implemented method may comprise: at a dynamic data packet routing service: receiving, via a network: one or more inputs for constructing a cascading data packet; one or more inputs identifying a plurality of networked entity nodes arranged in a defined order; and one or more cascading parameters for generating dynamic routing instructions for dynamically routing the cascading data packet across a network of entity node accounts, wherein the one or more cascading parameters include (a) routing sequencing parameters and (b) one or more temporal threshold parameters; configuring, by a microservice of the dynamic data packet routing service, the cascading data packet based on the one or more cascading parameters, wherein configuring the cascading data packet includes: encoding for the cascading data packet a set of dynamic routing instructions that, when executed, causes an automated routing of the cascading data packet along one or more entity nodes of the plurality of networked entity nodes in an order predefined by the routing sequencing parameters; encoding for the cascading data packet a set of temporal thresholds that sets a temporal limit for each instance of a routing of the cascading data packet to a respective entity node of the plurality of networked entity nodes based on the one or more temporal threshold parameters, wherein the temporal limit, when satisfied, causes an automatic re-routing of the cascading data packet from a current entity node of the plurality of networked entity nodes to a subsequent entity node of the plurality of networked entity nodes that follows the current entity node within the defined order; storing to a memory the cascading data packet and the configuration of the cascading data packet; and transmitting from the memory, via the network, the cascading data packet to a first networked entity node of the plurality of networked entity nodes in response to an input for launching the cascading data packet.

In some aspects, the computer-implemented method may further comprise: at the dynamic data packet routing service further: generating, based at least in part on the one or more inputs identifying the plurality of networked entity nodes arranged in the defined order, a data structure; storing, in the data structure, information that indicates each networked entity node in the plurality of networked entity nodes and the defined order in which the plurality of networked entity nodes is arranged; and providing, via the network, signaling indicating that the information has been successfully stored in the data structure.

In some aspects, the computer-implemented method may further comprise: at the dynamic data packet routing service further: receiving, via the network, an identifier for the data structure or one or more identifiers for the plurality of networked entity nodes; comparing the received identifier for the data structure with a stored identifier of the data structure or the received one or more identifiers for the plurality of networked entity nodes with one or more stored identifiers of the plurality of networked entity nodes; and selecting the data structure based at least in part on the comparing, wherein transmitting the cascading data packet is based at least in part on the selecting.

In some aspects, the information indicating each networked entity node in the plurality of networked entity nodes comprises a respective identifier of each of the plurality of networked entity nodes, and wherein the information indicating the defined order in which the plurality of networked entity nodes is arranged comprises a respective ranking for each network entity node of the plurality of network entity nodes.

In some aspects, the computer-implemented method may further comprise: at the dynamic data packet routing service further: initializing a counter for a first temporal threshold of the set of temporal thresholds, the first temporal threshold for the first networked entity node of the plurality of networked entity nodes; and storing to the memory a value of the counter.

In some aspects, the computer-implemented method may further comprise: at the dynamic data packet routing service further: receiving, from the first networked entity node, a response data packet, the response data packet indicating an approval by the first networked entity node; and terminating the automated routing of the cascading data packet to any other networked entity node of the plurality of networked entity nodes based at least in part on the response data packet indicating the approval by the first networked entity node, wherein terminating the automated routing comprises disabling the counter.

In some aspects, the computer-implemented method may further comprise: at the dynamic data packet routing service further: receiving, from the first networked entity node, a response data packet, the response data packet indicating a rejection by the first networked entity node; routing the cascading data packet to a second networked entity node of the plurality of networked entity nodes based at least in part on the response data packet indicating the rejection by the first networked entity node; initializing a second counter for a second temporal threshold of the set of temporal thresholds based at least in part on the response data packet indicating the rejection by the first networked entity node, the second temporal threshold for the second networked entity node of the plurality of networked entity nodes; and disabling the first counter for the first temporal threshold based at least in part on the response data packet indicating the rejection by the first networked entity node.

In some aspects, the computer-implemented method may further comprise: at the dynamic data packet routing service further: determining that the value of the counter has exceeded the first temporal threshold; routing the cascading data packet to a second networked entity node of the plurality of networked entity nodes based at least in part on determining that the value of the counter has exceeded the first temporal threshold; initializing a second counter for a second temporal threshold of the set of temporal thresholds based at least in part on determining that the value of the counter has exceeded the first temporal threshold, the second temporal threshold for the second networked entity node of the plurality of networked entity nodes; and disabling the first counter for the first temporal threshold based at least in part on determining that the value of the counter has exceeded the first temporal threshold.

In some aspects, the computer-implemented method may further comprise: at the dynamic data packet routing service further: providing, to a user interface, one or more first user interface input elements, the one or more first user interface input elements editable to indicate two or more networked entity nodes, wherein the one or more inputs identifying the plurality of networked entity nodes arranged in the defined order comprises a first user input being applied to the one or more first user interface input elements.

In some aspects, receiving the routing sequencing parameters is based at least in part on the first user input being applied to the one or more first user interface input elements.

In some aspects, the computer-implemented method may further comprise: at the dynamic data packet routing service further: providing, to a user interface, one or more first user interface input elements, the one or more first user interface input elements editable to indicate one or more temporal thresholds, wherein the one or more temporal threshold parameters are received based at least in part on a first user input being applied to the one or more first user interface input elements.

A computer-program product may comprise a non-transitory machine-readable storage medium storing computer instructions that, when executed by one or more processors, perform operations comprising: at a dynamic data packet routing service: receiving, via a network: one or more inputs for constructing a cascading data packet; one or more inputs identifying a plurality of networked entity nodes arranged in a defined order; and one or more cascading parameters for generating dynamic routing instructions for dynamically routing the cascading data packet across a network of entity node accounts, wherein the one or more cascading parameters include (a) routing sequencing parameters and (b) one or more temporal threshold parameters; configuring, by a microservice of the dynamic data packet routing service, the cascading data packet based on the one or more cascading parameters, wherein configuring the cascading data packet includes: encoding for the cascading data packet a set of dynamic routing instructions that, when executed, causes an automated routing of the cascading data packet along one or more entity nodes of the plurality of networked entity nodes in an order predefined by the routing sequencing parameters; encoding for the cascading data packet a set of temporal thresholds that sets a temporal limit for each instance of a routing of the cascading data packet to a respective entity node of the plurality of networked entity nodes based on the one or more temporal threshold parameters, wherein the temporal limit, when satisfied, causes an automatic re-routing of the cascading data packet from a current entity node of the plurality of networked entity nodes to a subsequent entity node of the plurality of networked entity nodes that follows the current entity node within the defined order; storing to a memory the cascading data packet and the configuration of the cascading data packet; and transmitting from the memory, via the network, the cascading data packet to a first networked entity node of the plurality of networked entity nodes in response to an input for launching the cascading data packet.

In some aspects, the computer-program product may perform operations further comprising: at the dynamic data packet routing service further: generating, based at least in part on the one or more inputs identifying the plurality of networked entity nodes arranged in the defined order, a data structure; storing, in the data structure, information that indicates each networked entity node in the plurality of networked entity nodes and the defined order in which the plurality of networked entity nodes is arranged; and providing, via the network, signaling indicating that the information has been successfully stored in the data structure.

In some aspects, the computer-program product may perform operations further comprising: at the dynamic data packet routing service further: receiving, via the network, an identifier for the data structure or one or more identifiers for the plurality of networked entity nodes; comparing the received identifier for the data structure with a stored identifier of the data structure or the received one or more identifiers for the plurality of networked entity nodes with one or more stored identifiers of the plurality of networked entity nodes; and selecting the data structure based at least in part on the comparing, wherein transmitting the cascading data packet is based at least in part on the selecting.

In some aspects, the information indicating each networked entity node in the plurality of networked entity nodes comprises a respective identifier of each of the plurality of networked entity nodes, and wherein the information indicating the defined order in which the plurality of networked entity nodes is arranged comprises a respective ranking for each network entity node of the plurality of network entity nodes.

In some aspects, the computer-program product may perform operations further comprising: at the dynamic data packet routing service further: initializing a counter for a first temporal threshold of the set of temporal thresholds, the first temporal threshold for the first networked entity node of the plurality of networked entity nodes; and storing to the memory a value of the counter.

In some aspects, the computer-program product may perform operations further comprising: at the dynamic data packet routing service further: receiving, from the first networked entity node, a response data packet, the response data packet indicating an approval by the first networked entity node; and terminating the automated routing of the cascading data packet to any other networked entity node of the plurality of networked entity nodes based at least in part on the response data packet indicating the approval by the first networked entity node, wherein terminating the automated routing comprises disabling the counter.

A computer-implemented system may comprise: one or more processors; a memory; and a computer-readable medium operably coupled to the one or more processors, the computer-readable medium having computer-readable instructions stored thereon that, when executed by the one or more processors, cause a computing device to perform operations comprising: at a dynamic data packet routing service: receiving, via a network: one or more inputs for constructing a cascading data packet; one or more inputs identifying a plurality of networked entity nodes arranged in a defined order; and one or more cascading parameters for generating dynamic routing instructions for dynamically routing the cascading data packet across a network of entity node accounts, wherein the one or more cascading parameters include (a) routing sequencing parameters and (b) one or more temporal threshold parameters; configuring, by a microservice of the dynamic data packet routing service, the cascading data packet based on the one or more cascading parameters, wherein configuring the cascading data packet includes: encoding for the cascading data packet a set of dynamic routing instructions that, when executed, causes an automated routing of the cascading data packet along one or more entity nodes of the plurality of networked entity nodes in an order predefined by the routing sequencing parameters; encoding for the cascading data packet a set of temporal thresholds that sets a temporal limit for each instance of a routing of the cascading data packet to a respective entity node of the plurality of networked entity nodes based on the one or more temporal threshold parameters, wherein the temporal limit, when satisfied, causes an automatic re-routing of the cascading data packet from a current entity node of the plurality of networked entity nodes to a subsequent entity node of the plurality of networked entity nodes that follows the current entity node within the defined order; storing to the memory the cascading data packet and the configuration of the cascading data packet; and transmitting from the memory, via the network, the cascading data packet to a first networked entity node of the plurality of networked entity nodes in response to an input for launching the cascading data packet.

In some aspects of the computer-implemented system, the computer-readable instructions, when executed by the one or more processors, may further cause the computing device to perform operations comprising: at the dynamic data packet routing service further generating, based at least in part on the one or more inputs identifying the plurality of networked entity nodes arranged in the defined order, a data structure; storing, in the data structure, information that indicates each networked entity node in the plurality of networked entity nodes and the defined order in which the plurality of networked entity nodes is arranged; and providing, via the network, signaling indicating that the information has been successfully stored in the data structure.

In some aspects of the computer-implemented system, the computer-readable instructions, when executed by the one or more processors, may further cause the computing device to perform operations comprising: at the dynamic data packet routing service further: receiving, via the network, an identifier for the data structure or one or more identifiers for the plurality of networked entity nodes; comparing the received identifier for the data structure with a stored identifier of the data structure or the received one or more identifiers for the plurality of networked entity nodes with one or more stored identifiers of the plurality of networked entity nodes; and selecting the data structure based at least in part on the comparing, wherein transmitting the cascading data packet is based at least in part on the selecting.

### BRIEF DESCRIPTION OF THE FIGURES

FIG. 1 illustrates a schematic representation of a system 100 in accordance with one or more embodiments of the present application;

FIG. 1A illustrates a schematic representation of a system 100A in accordance with one or more embodiments of the present application;

FIG. 2 illustrates an example method 200 in accordance with one or more embodiments of the present application;

FIG. 2A illustrates an example method 200A in accordance with one or more embodiments of the present application;

FIG. 3 illustrates an example implementation of a user interface for configuring or constructing an entity node cascade in accordance with one or more embodiments of the present application;

FIG. 4 illustrates an example implementation of a user interface for configuring or constructing an entity node cascade in accordance with one or more embodiments of the present application;

FIG. 5 illustrates an example implementation of a user interface for configuring or constructing a digital activity profile artifact in accordance with one or more embodiments of the present application;

FIG. 6 illustrates an example implementation of a user interface for configuring or constructing a digital activity profile artifact in accordance with one or more embodiments of the present application;

FIG. 7 illustrates an example implementation of a user interface for identifying an entity node cascade for a target digital activity profile artifact in accordance with one or more embodiments of the present application; and

FIG. 8 illustrates an example implementation of a user interface for dynamically constructing an entity node cascade for a target digital activity profile artifact in accordance with one or more embodiments of the present application.

### DESCRIPTION OF THE PREFERRED EMBODIMENTS

The following description of the preferred embodiments of the present application are not intended to limit the inventions to these preferred embodiments, but rather to enable any person skilled in the art to make and use these inventions.

### 1. System for Intelligently Routing Digital Activity Profile Data in an Automated Scheduled Cascade

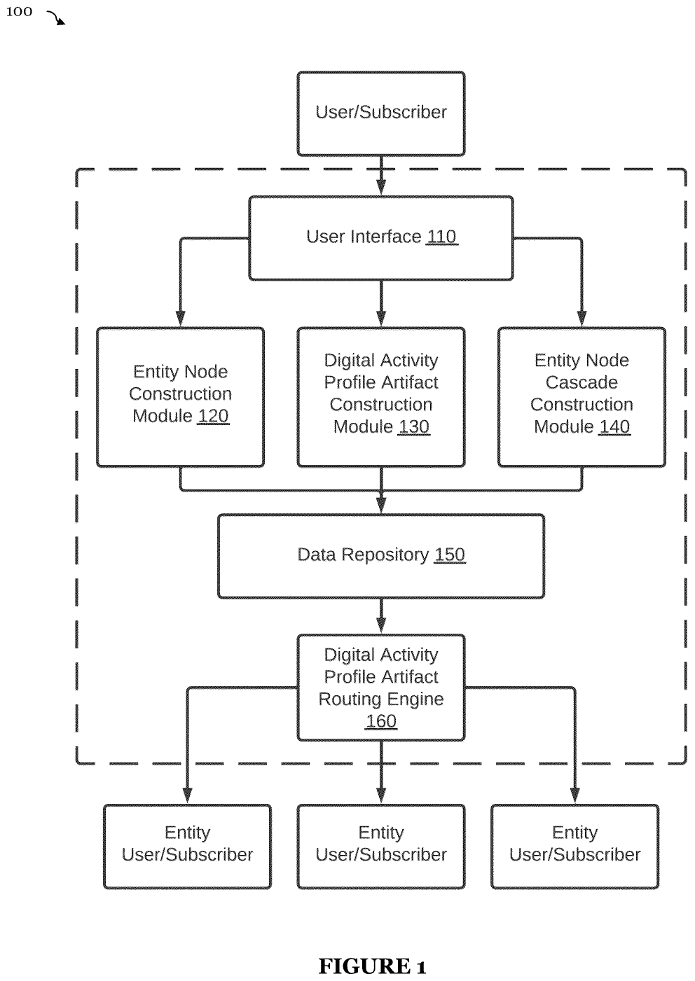

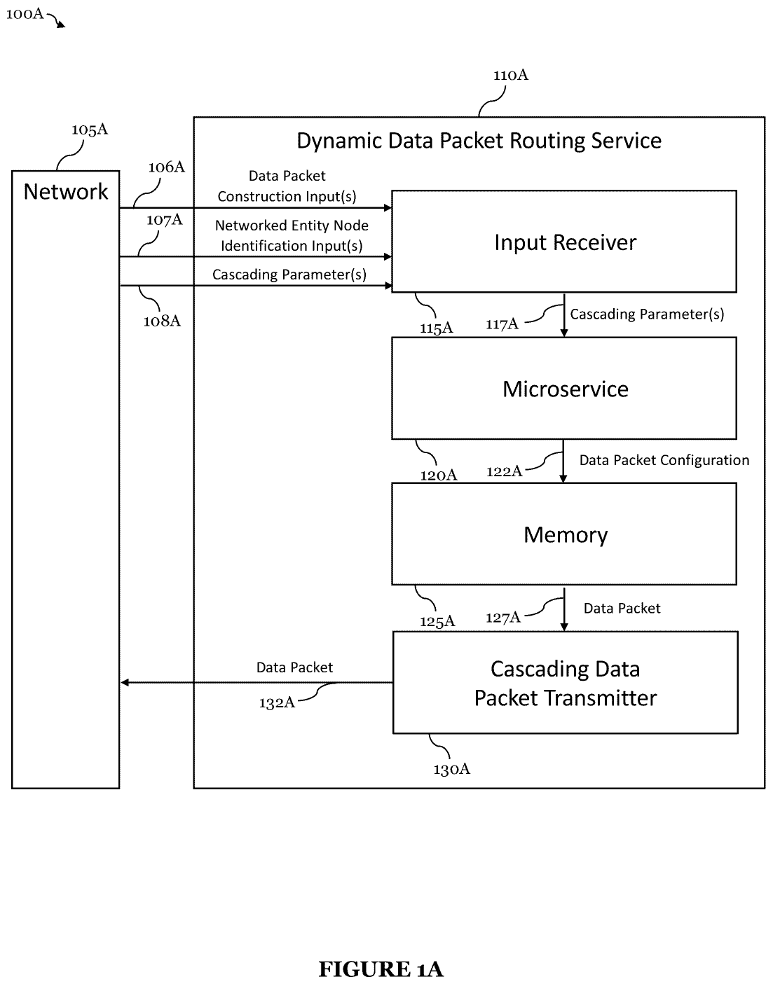

As shown in FIG. 1, a system 100 for intelligently routing digital activity profile data in an automated scheduled cascade may include a user interface 110, an entity node profile construction module 120, a digital activity profile artifact construction module 130, an entity node cascade construction module 140, a data repository 150, and a digital activity profile artifact routing engine 160.

### 1.10 User Interface

The user interface 110 may preferably function to receive user/subscriber input in any suitable input format. In one or more embodiments, user interface 110 may enable one or more users of system 100 to construct, configure, and/or modify one or more entity node profiles, one or more digital activity profile artifacts (as described in 2.20), and/or one or more entity node cascades (as described in 2.10). Accordingly, user interface 110 may be in operable communication with entity node profile construction module 120, digital activity profile artifact construction module 130, and/or entity node cascade construction module 140. In various embodiments, user interface 110 may function to transmit user input data from one or more users/subscribers to one or more components of system 100, and/or user interface 110 may function to transmit and/or display system output data from one or more components of system 100 to the one or more users/subscribers of system 100.

### 1.20 Entity Node Construction Module

The entity node construction module 120 may preferably function to construct, configure, and/or modify one or more entity nodes based on user/subscriber input of one or more entity node properties or characteristics. As generally referred to herein, an entity node may relate to a data object or data structure that may include one or more pieces of data relating to a distinct entity (e.g., an individual, organization, corporation, and/or the like). In some embodiments, entity node construction module 120 may function to receive user input (e.g., via user interface 110) that may function to construct an entity node either directly or via construction of an entity node profile (sometimes referred to herein as an entity profile). As generally referred to herein, an entity node profile may relate to a composite data structure that may include each entity node property or characteristic for a corresponding entity node. Preferably, each entity node may be associated with one or more unique entity node ID values (e.g., unique name, unique numeric ID, and/or the like) that may preferably facilitate entity discoverability (e.g., via searching) and/or entity node identification and/or selection. In some embodiments, an entity node profile may include one or more entity node profile graphical layouts or arrangements that may enable display of the one or more entity node properties or characteristics of the corresponding entity node via user interface 110.

In some embodiments, entity node construction module 120 may additionally or alternatively function to incorporate one or more entity nodes into an entity node nexus (sometimes referred to herein as an entity node network). As generally referred to herein, an entity node nexus may relate to a collection or network of one or more distinct entity nodes. In some embodiments, entity node construction module 120 may enable one or more constructed entity nodes to be discoverable in the entity node nexus based on one or more entity node properties or characteristics. In such embodiments, one or more components of system 100 may function to initiate, implement, and/or execute an automated or computer-implemented search for one or more distinct entity nodes in the entity node nexus based on search queries or search parameters that may include one or more entity node property or characteristic values.

### 1.30 Digital Activity Profile Artifact Construction Module

The digital activity profile artifact construction module 130 (sometimes referred to herein as the digital activity artifact construction module 130) may preferably function to construct, configure, and/or modify one or more digital activity profile artifacts (sometimes referred to herein as digital activity artifacts) based on user/subscriber input of one or more digital activity properties or characteristics. A digital activity profile artifact (digital activity artifact), as generally referred to herein, may relate to a composite data structure that may function to store one or more elements of data relating to characteristics defining and/or relating to a distinct task or activity that may be partially and/or completely implemented, initiated, executed, and/or otherwise associated with one or more entities. In some embodiments, digital activity profile artifact construction module 130 may function to receive user input (e.g., via user interface 110) that may function to construct or configure a digital activity profile artifact based on user input of one or more digital activity property values and/or digital activity characteristics that may function to define the distinct activity or task represented by the digital activity profile artifact.

### 1.40 Entity Node Cascade Construction Module

The entity node cascade construction module 140 may preferably function to construct, configure, and/or modify one or more entity node cascades based on user/subscriber input of one or more entity node identifying values (as described in 2.10). As discussed in 2.10, an entity node cascade may refer to a sequential data structure that may include a configuration or arrangement of one or more entity node identifying values or labels in a distinct sequence of entity nodes. Accordingly, in some preferred embodiments, entity node cascade construction module 140 may function to receive user/subscriber input (e.g., via user interface 110) that may construct or configure one or more entity node cascades by identifying and/or otherwise selecting one or more entity nodes for each distinct entity node cascade.

### 1.50 Data Repository

In some embodiments, system 100 may include data repository 150. In such embodiments, data repository 150 may preferably function to receive and/or store data collected by and/or constructed by system 100, including, but not limited to, one or more entity nodes, one or more entity node profiles, one or more entity node nexuses, one or more digital activity artifacts, one or more entity node cascades, and/or any other data collected, generated, and/or processed by system 100. In various embodiments, data repository 150 may be in operable communication with one or more components of system 100. In one or more embodiments, data repository 150 may be queried by one or more components of system 100 and/or one or more users/subscribers of system 100 (e.g., via user interface 110) to provide access to data stored in data repository 150. Additionally, or alternatively, in some embodiments, system 100 may be in operable communication with one or more external data repositories 150 (e.g., remote servers, cloud storage, external network storage, and/or the like). Additionally, or alternatively, in some embodiments, data repository 150 may be implemented as a plurality of data repositories 150.

### 1.60 Digital Activity Profile Artifact Routing Engine

The digital activity profile artifact routing engine 160 (sometimes referred to herein as digital activity artifact router 160 or router 160) may preferably function to route a target digital activity profile artifact to one or more entity nodes based on an entity node cascade associated with the target digital activity profile artifact. In some preferred embodiments, digital activity profile artifact routing engine 160 may function to generate a routing schedule based on the associated entity node cascade that may define a temporal routing schedule or routing sequence (sometimes referred to herein as a scheduled sequential routing) for the target digital activity profile artifact. In some such embodiments, digital activity artifact router 160 may function to selectively route one or more digital activity artifact queries to each entity node or entity of the associated entity node cascade in order according to the temporal routing schedule or routing sequence.

### 1A. System for Intelligently Routing Digital Activity Profile Data in an Automated Scheduled Cascade

As shown in FIG. 1A, a system 100A for intelligently routing digital activity profile data in an automated scheduled cascade may include a network 105A and a dynamic data packet routing service 110A. The dynamic data packet routing service 110A may include an input receiver 115A, microservice 120A, a memory 125A, and a cascading data packet transmitter 130A.

### 1.05A Network

The network 105A may preferably function to provide inputs and/or cascading parameters to dynamic data packet routing service 110A (e.g., to input receiver 115A) and to provide cascading data packets from dynamic data packet routing service 110A (e.g., from cascading data packet transmitter 130A). For instance, the network 105A may provide one or more inputs for constructing a cascading data packet (e.g., data packet construction input(s) 106A) and one or more inputs identifying a set of networked entity nodes arranged in a defined order (e.g., networked entity node identification inputs 107A) to dynamic data packet routing service 110A. Additionally, the network 105A may provide one or more cascading parameters (e.g., cascading parameter(s) 108A) for generating dynamic routing instructions to dynamic data packet routing service 110A. The dynamic routing instructions may be for dynamically routing the cascading data packet across a network of entity node accounts and the one or more cascading parameters may include routing sequence parameters and/or one or more temporal threshold parameters. Additionally, the network 105A may be configured to receive a cascading data packet (e.g., data packet 132A) from dynamic data packet routing service and to provide the cascading data packet to a first networked entity node of the set of networked entity nodes in response to an input for launching the cascading data packet (e.g., from a user interface).

Network 105A may be a system of interconnected devices that communicate with each other. Network 105A may, for instance, include hardware components (e.g., computers, servers, routers) and software protocols that define rules for data exchange. In some examples, the hardware components and software protocols may be utilized to exchange data packets between a user interface and a service (e.g., dynamic data packet routing service 110A).

In some examples, network 105A may be associated with one or more aspects of system 100. For instance, information exchanged between user interface 110 and one or more of entity node construction module 120, digital activity profile artifact construction module 130, and entity node cascade construction module 140 may occur via network 105A, where such information may include one or more inputs and/or one or more cascading parameters (e.g., user input received from user interface 110). Additionally, information exchanged between digital activity profile artifact routing engine 160 and one or more entity nodes may occur via network 105A, where such information may include a cascading data packet (e.g., a target digital activity profile artifact).

### 1.10A Dynamic Data Packet Routing Service

The dynamic data packet routing service 110A may preferably function to receive inputs and/or cascading parameters via network 105A and to output a corresponding cascading data packet via network 105A. The dynamic data packet routing service 110A may include an input receiver 115A, microservice 120A, a memory 125A, and a cascading data packet transmitter 130A. In some examples, dynamic data packet routing service 110A may be associated with one or more aspects of system 100. For instance, dynamic data packet routing service 110A may include the functionality of each of entity node construction module 120, digital activity profile artifact construction module 130, entity node cascade construction module 140, data repository 150, and digital activity profile artifact routing engine 160.

### 1.15A Input Receiver

The input receiver 115A may preferably function to receive inputs and/or cascading parameters via network 105A. For instance, input receiver 115A may receive one or more inputs for constructing a cascading data packet (e.g., data packet construction input(s) 106A) and one or more inputs identifying a set of networked entity nodes arranged in a defined order (e.g., networked entity node identification inputs 107A) via network 105A. Additionally, or alternatively, input receiver 115A may receive one or more cascading parameters (e.g., cascading parameter(s) 108A) for generating dynamic routing instructions via network 105A. The dynamic routing instructions may be for dynamically routing the cascading data packet across a network of entity node accounts and the one or more cascading parameters may include routing sequence parameters and/or one or more temporal threshold parameters. Input receiver 115A may provide an indication 117A of the one or more cascading parameters to microservice 120A.

Input receiver 115A may, for instance, be a module that receives and processes incoming data, signals, or messages from a network (e.g., network 105A). Input receiver 115A may function as an endpoint within dynamic data packet routing service 110A for traffic received from network 105A. In some examples, input receiver 115A may monitor for data packets and may decode and process the data packets to extract relevant information (e.g., inputs, cascading parameters).

In some examples, input receiver 115A may be associated with one or more aspects of system 100. For instance, input receiver 115A may be used to receive information from user interface 110 for entity node construction module 120, digital activity profile artifact construction module 130, and entity node cascade construction module 140, where such information may include one or more inputs and/or one or more cascading parameters (e.g., user input received from user interface 110).

### 1.20A Microservice

The microservice 120A may preferably function to configure the cascading data packet (e.g., data packet 132A) based on the one or more cascading parameters (e.g., cascading parameter(s) 108A). Configuring the cascading data packet may include encoding for the cascading data packet a set of dynamic routing instructions that, when executed, causes an automated routing of the cascading data packet along one or more entity nodes of the set of networked entity nodes in an order predefined by the routing sequencing parameters. Additionally, configuring the cascading data packet may include encoding for the cascading data packet a set of temporal thresholds that sets a temporal limit for each instance of a routing of the cascading data packet to a respective entity node of the plurality of networked entity nodes based on the one or more temporal threshold parameters. In some such examples, the temporal limit, when satisfied, causes an automatic re-routing of the cascading data packet from a current entity node of the plurality of networked entity nodes to a subsequent entity node of the plurality of networked entity nodes that follows the current entity node within the defined order. Microservice 120A may provide a configuration of the cascading data packet (e.g., data packet configuration 122A) to memory 125A, where the configuration of the cascading data packet may include the set of dynamic routing instructions and/or the set of temporal thresholds.

Microservice 120A may be a module configured to perform a specific function within a larger system architecture. For instance, in the present disclosure, microservice 120A may be a module for configuring a cascading data packet. Microservice 120A may include its own storage (e.g., its own database), may maintain its own logic, and may be independently scalable relative to other modules of dynamic data packet routing service 110A. Microservice 120A may be associated with one or more aspects of system 100. In some examples, microservice 120A may perform functions associated with one or more of entity node construction module 120, digital activity profile artifact construction module 130, and entity node cascade construction module 140. For instance, microservice 120A may configure a digital activity profile artifact (e.g., a cascading data packet that includes a digital activity profile artifact).

### 1.25A Memory

The memory 125A may preferably function to store the cascading data packet and the configuration of the cascading data packet (e.g., data packet configuration 122A). The memory 125A may provide, to cascading data packet transmitter 130A, the cascading data packet (e.g., data packet 127A). Memory 125A may be an example of a database or a non-volatile memory device configured to store information associated with the cascading data packet and the configuration of the cascading data packet. In some examples, memory 125A may be implemented by one or more aspects of system 100. For instance, memory 125A may be an example of or may implement one or more aspects of data repository 150.

### 1.30A Cascading Data Packet Transmitter

The cascading data packet transmitter 130A may transmit (e.g., provide) to network 130A, the cascading data packet to a first networked entity node of the set of networked entity nodes. The cascading data packet transmitter 130A may provide the cascading data packet in response to an input for launching the cascading data packet (e.g., received via a user interface). Additionally, cascading data packet transmitter 130A may transmit the cascading data packet to other networked entity nodes of the set of networked entity nodes (e.g., as part of the automatic re-routing).

Cascading data packet transmitter 130A may, for instance, be a module that sends outgoing data, signals, or messages to a network (e.g., network 105A). Cascading data packet transmitter 130A may function as an endpoint within dynamic data packet routing service 110 for traffic being sent to network 105A (e.g., a cascading data packet). In some examples, cascading data packet transmitter 130A may receive information from memory 125A that cascading data packet transmitter 130A encodes into a cascading data packet. Alternatively, the information retrieved from memory 125A may already be formatted as a cascading data packet when retrieved from memory 125A.

In some examples, cascading data packet transmitter 130A may be associated with one or more aspects of system 100. For instance, cascading data packet transmitter 130A may be used to transmit information from digital activity profile artifact routing engine 160, where such information may include a cascading data packet (e.g., a target digital activity profile artifact).

### 2. Method for Intelligently Routing Digital Activity Profile Data in an Automated Scheduled Cascade

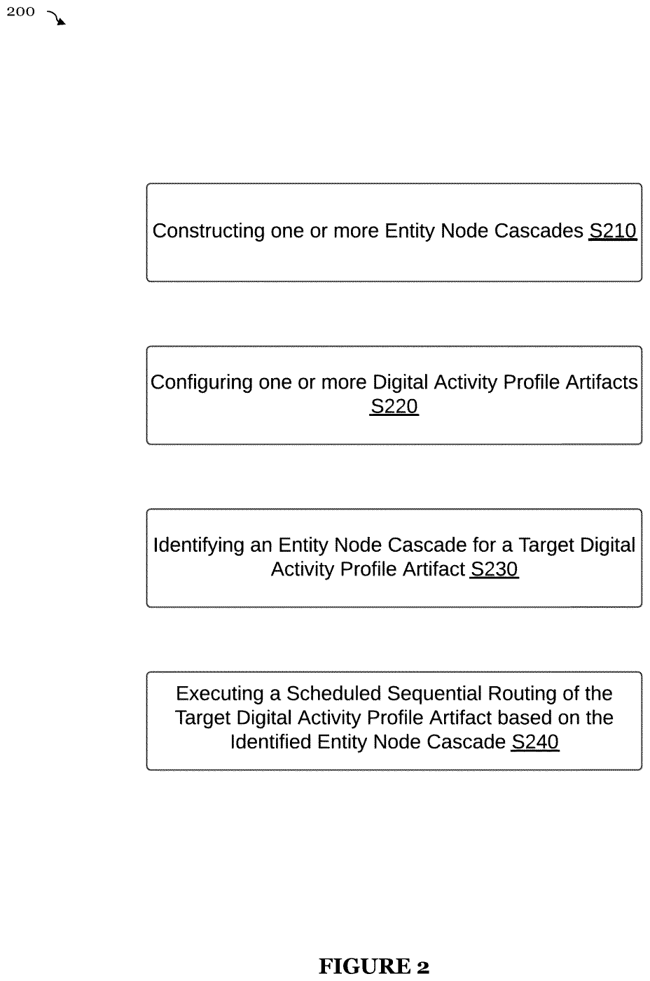

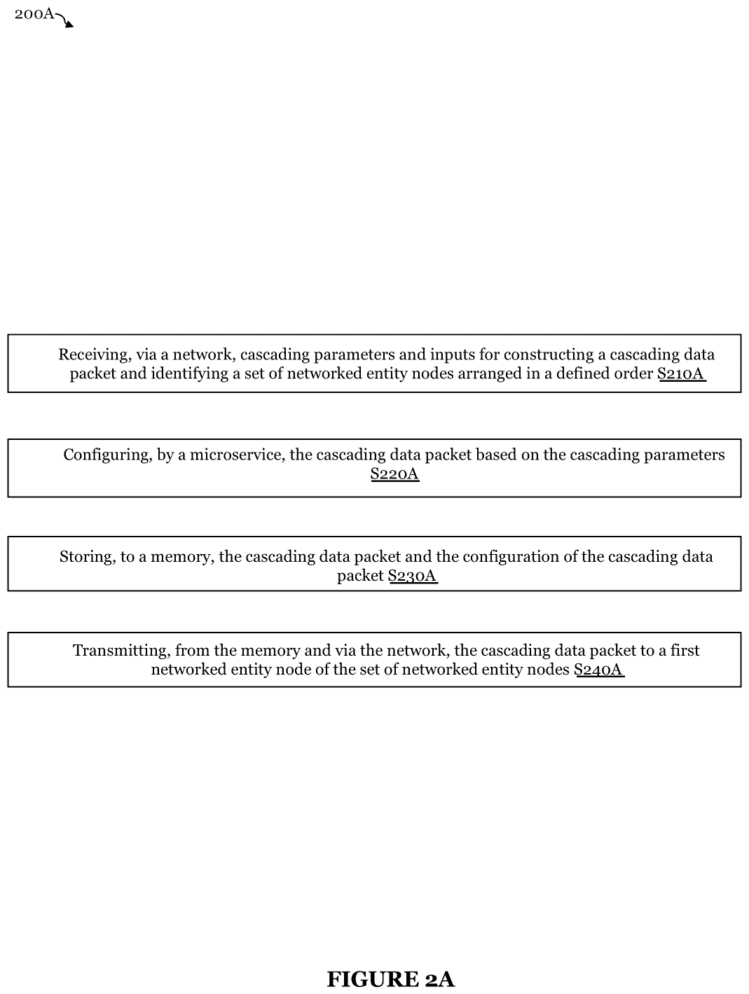

As shown in FIG. 2, a method 200 for intelligently routing digital activity profile data in an automated scheduled cascade includes constructing one or more entity node cascades S210, configuring one or more digital activity profile artifacts S220, identifying an entity node cascade for a target digital activity profile artifact S230, and executing a scheduled sequential routing of the target digital activity profile artifact based on the identified entity node cascade S240.

### 2.10 Constructing One or More Entity Node Cascades

S210, which includes constructing one or more entity node cascades, may function to construct one or more entity node cascades for informing or defining a scheduled sequential routing of one or more digital activity profile artifacts. As generally referred to herein, an entity node cascade (sometimes referred to as an entity cascade or entity node sequencer) may refer to a sequential data structure (e.g., a matrix, array, table, and/or the like) that may include a configuration or arrangement of one or more entity node identifying values or labels in a distinct sequence of entity nodes that may define or inform a scheduled sequential routing for a digital activity profile artifact between or among one or more entities. An entity, as used herein, may refer to an individual, organization, corporation, and/or the like. An entity node, as generally referred to herein, may relate to a node in an entity node nexus (or entity node network) that may function as a digital data object that may store and/or represent one or more pieces of data relating to a distinct entity. A digital activity profile artifact, as generally referred to herein, may relate to a composite data structure that may function to store one or more elements of data relating to characteristics defining and/or relating to a distinct task or activity that may be partially and/or completely implemented, initiated, executed, and/or otherwise associated with one or more entities.

### Entity Node Cascade User Interface

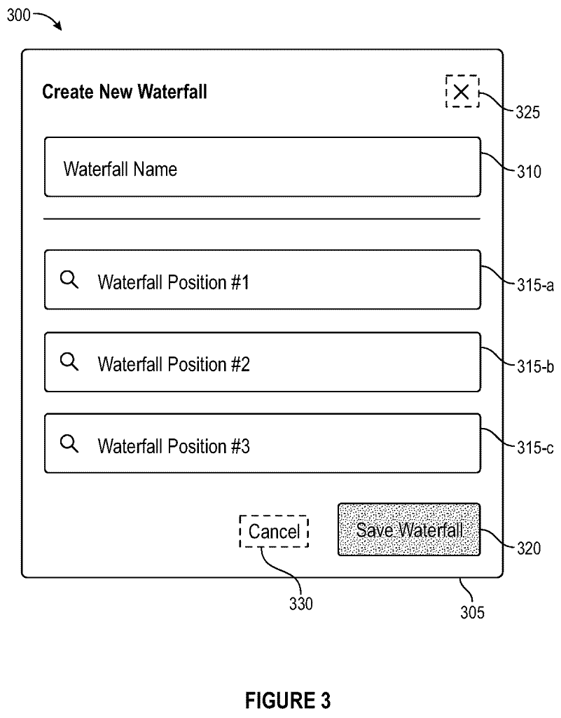

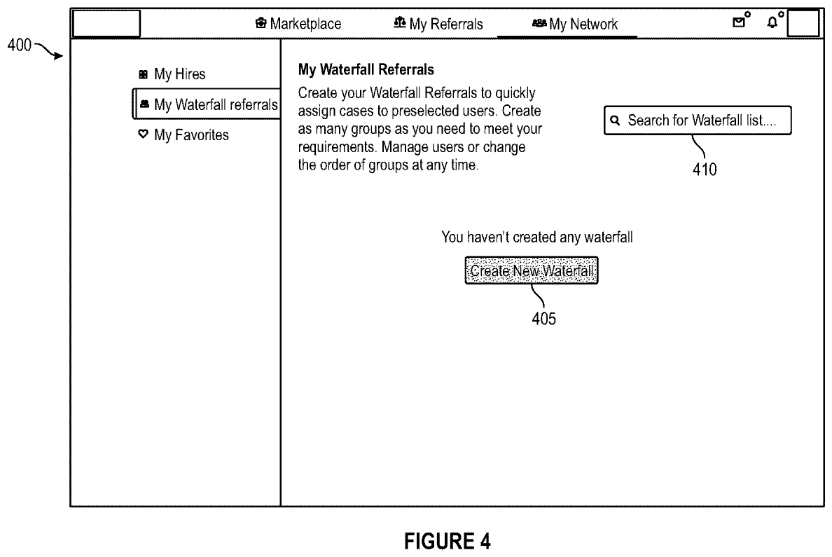

Preferably, the one or more entity node cascades may be constructed based on user or subscriber input via an entity node cascade user interface (sometimes referred to herein as the “cascade user interface”), as shown by way of example in FIGS. 3 and 4. In one or more embodiments, the cascade user interface may be implemented as a graphical user interface (GUI). For instance, as depicted in FIG. 3, user interface 300 may be a GUI that includes a container 305.

In one or more embodiments, the entity node cascade user interface may include an interactive or selectable interface object (e.g., a button or the like) that may be interacted with (e.g., via any suitable user interaction/selection mechanism) that may function to initiate the construction of a new entity node cascade. Additionally, or alternatively, in one or more embodiments, the entity node cascade user interface may include an interactive or selectable interface object that may be selected or interacted with to initiate a storing or saving of the current entity node cascade (e.g., storing or saving to a data repository). A non-limiting example of the interactive or selectable interface object may include interactive or selectable interface object 320 within container 305 of user interface 300.

In one or more embodiments, the entity node cascade user interface may include an entity node cascade identifier (ID) input field (e.g., a text input field, numeric input field, and/or the like) that may function to receive user input (e.g., one or more text strings, one or more numeric values, and/or the like) of an entity node cascade identifying (ID) label (e.g., a text-label identifying a user-selected and/or user-input name, title, and/or ID of the entity node cascade). Preferably, each entity node cascade may be configured with a distinct entity node cascade identifying label, such that each entity node cascade may be discoverable (e.g., by search query) via its corresponding distinct entity node cascade identifying label. A non-limiting example of the entity node cascade ID input field may include entity node cascade ID input field 310 of user interface 300.

In one or more embodiments, when constructing, configuring, or otherwise modifying a target entity node cascade, the entity node cascade user interface may include one or more entity node identifier (ID) input fields (e.g., text input fields, numeric input fields, and/or the like) that may each function to receive user input (e.g., one or more text strings, one or more numeric values, and/or the like) of an entity node identifying label (sometimes referred to herein as an entity node ID or entity ID). An entity node ID may include one or more values (e.g., one or more entity names, one or more entity titles, one or more entity identification numbers, and/or the like) that may function to identify a distinct entity node and/or a distinct entity represented by a corresponding distinct entity node. In some such embodiments, the one or more entity identifier input fields may additionally or alternatively function as entity identifier search input fields that may function to search for one or more entity nodes that may be associated with entity identifying labels matching user/subscriber input in the entity identifier search input fields. In some such embodiments, the one or more entity identifier input fields may be pre-populated, and/or one or more search input fields may be pre-populated, with one or more entity node IDs of entities or entity nodes that may represent one or more user-preferred entities or entity nodes (e.g., entities that the user may have identified as preferred entities). Non-limiting examples of the entity node ID input fields may include entity node ID input fields 315-a, 315-b, and 315-c of user interface 300.

In some preferred embodiments, the one or more entity node identifier input fields may be arranged in a visual or graphical sequence (e.g., a vertical list, a horizontal list, and/or the like) that may function to visually represent the distinct sequence of entity nodes for the target entity node cascade (e.g., a top-to-bottom sequence of a vertical list, a left-to-right vertical list, and/or any other suitable visual or graphical sequence). Such embodiments may function to facilitate user/subscriber comprehension with a visual representation of the distinct sequence of entity nodes. As a non-limiting example, an entity node cascade may include or be represented in the GUI by a vertical list of three entity node ID input fields that may represent a top-down sequence of entity nodes, whereby the top-most entity node ID may represent the first entity node in the sequence, the middle (i.e., second from the top) entity node ID may represent the second entity node in the sequence, and the bottom (i.e., third from the top) entity node ID may represent the third entity node in the sequence. It shall be noted the entity node cascade may include a list of n entity nodes, where n is greater than zero, and may be represented in any suitable arrangement in the entity node cascade user interface.

In some embodiments, a user/subscriber may function to configure and/or modify the distinct sequence of entity nodes for the target entity node cascade by manipulating the graphical sequence of the entity node ID input fields. In various embodiments, such configuration may include, but is not limited to, click-and-drag or touch-and-drag manipulation of the input fields to different locations in the graphical sequence, selecting different entity node IDs for each input field via dropdown list associated with each input field, by modifying entity node IDs in the input fields (e.g., by text-input of new entity node IDs), and/or any other suitable means for changing or modifying the graphical sequence of entity node ID input fields.

Additionally, or alternatively, in some embodiments, each of the one or more entity node ID input fields may include or be associated with a distinct sequence position value that may function to identify the position of the corresponding entity node ID in the distinct sequence of entity nodes. In such embodiments, each position input value may include an enumerator such as a number (e.g., 1, 2, 3, etc.), a character (e.g., A, B, C, etc.), or other likewise enumerator suitable for identifying a position or ranking. In some such embodiments, a user may select an enumerator for each entity node ID input field (e.g., via a selection control such as a dropdown list, radio buttons, and/or the like) and/or directly input an enumerator (e.g., via a sequence position value input field), such that the user-selected or user-input enumerators may function to define the distinct sequence of entity nodes for the entity node cascade. In some such embodiments, the distinct entity node sequence may not be associated with the graphical sequence of entity node ID input fields. As a non-limiting example, a target entity node cascade may include or be represented in the GUI by a vertical list of entity node ID input fields, with each of the entity node ID input fields having a corresponding sequence position input field. In such an example, the distinct entity node sequence of the target entity node cascade may be defined by the values in the sequence position input fields, rather than the visual or graphical position (e.g., top, middle, bottom of the vertical list) of the corresponding entity node ID input fields.

In one or more embodiments, the entity node cascade user interface may include one or more interactive or selectable interface objects (e.g., buttons or the like) that may function to prematurely terminate a construction of a new entity node cascade. Additionally, or alternatively, the one or more interactive or selectable interface objects may be selected or interacted with to prevent a storing or saving of the current entity node cascade (e.g., the storing or saving to a data repository). A non-limiting example of the one or more interactive or selectable interface objects may include interactive or selectable interface object 325 and/or interactive or selectable interface object 330 within container 305 of user interface 300. In some examples, upon interacting with interactive or selectable interface object 325 or interactive or selectable interface object 330, container 305 may be deleted, disabled, or hidden from view. Additionally, or alternatively, upon the interacting with interactive or selectable interface objects 325 or 330, user interface 400 of FIG. 4 may be loaded, enabled, or brought into view.

In one or more embodiments, the container 305 of user interface 300 may be loaded (e.g., enabled, brought into view) via interaction with an interactive or selectable interface object (e.g., a button or the like). A non-limiting example of the interactive or selectable interface object may include interactive or selectable interface object 405 of user interface 400. In some examples, upon interacting with interactive or selectable interface object 405, a view of user interface 400 may be at least partially obscured by container 305 or may otherwise be deleted or disabled.

In one or more embodiments, user interface 400 may be configured to display a list of previously saved or stored entity node cascades (e.g., previously stored or saved via user interface 300). Additionally, or alternatively, user interface 400 may include a search input field 410 that may be interacted with (e.g., typed into) to filter a list of previously saved or stored entity node cascades and/or to select a particular entity node cascade from the list. Selecting a particular entity node cascade from the list may, in some examples, load a corresponding container 305 with entity node cascade ID input field 310 and entity node ID fields 315-a, 315-b, and 315-c pre-filled with previously saved or stored values. In such examples, the entity node cascade may be updated via interaction with the interactive or selectable interface object 320 and corresponding entity node cascade ID input fields 310 or entity node ID fields 315-a, 315-b, and 315-c.

### Entity Node Cascade Properties

Preferably, each of the one or more entity node cascades may include data and/or metadata relating to one or more entity node cascade properties. As generally referred to herein, a property of a distinct entity node cascade may relate to a data and/or metadata value (e.g., numeric, text, string, and/or the like) that may be descriptive of and/or otherwise associated with the distinct entity node cascade. In various embodiments, entity node cascade properties may include, but are not limited to, one or more entity node cascade identifier (ID) values (e.g., text labels, numeric ID values, enumerators, and/or the like), one or more entity node cascade location or geographic values associated with entity nodes of the entity node cascade (e.g., geographic region text labels, geographic region ID values, address text labels, and/or the like), one or more activity or task categories (e.g., a particular category of digital activity artifact), one or more categorical labels and/or categorical values, and/or any other suitable property or characteristic values that may define or otherwise be associated with an entity node cascade.

In some embodiments, each entity node cascade may be associated with a distinct user/subscriber. As a non-limiting example, S210 may function to associate a constructed entity node cascade with a user/subscriber who initiated the construction of the entity node cascade. Accordingly, each user/subscriber may be associated with one or more entity node cascades. In some such embodiments, each user/subscriber may function to view, modify, add, remove, and/or otherwise configure one or more entity node cascades associated with the user/subscriber via the entity node cascade user interface.

### Entity Node Validation

In some preferred embodiments, S210 may function to implement or otherwise execute entity node validation checks for each entity node identified, labeled, or otherwise included in an entity node cascade. Preferably, an entity node validation check of a distinct entity node may function to ensure that the corresponding entity represented by the entity node (e.g., individual, organization, corporation, and/or the like) may be validated for a particular digital activity (e.g., an entity is appropriately licensed, credentialed, authorized, and/or otherwise validated for a particular digital activity).

In some such embodiments, entity node validation checks may be executed concurrently or contemporaneously with adding and/or modifying the entity node identifying ID labels included in the entity node cascade (e.g., concurrent with a user inputting or selecting an entity node ID in an entity node ID input field). In some embodiments, S210 may function to electronically transmit or send one or more entity validation requests or queries to one or more API entity validation endpoints, and in turn S210 may function to receive one or more entity validation responses from the one or more API entity validation endpoints. In some such embodiments, an entity validation request or query may include entity identifying data including, but not limited to, one or more entity node ID values, one or more entity characteristic identifying values (e.g., geographic region of an entity, name of an entity, title of an entity, practice area and/or field of work of an entity, and/or the like), and/or any other suitable data for identifying a particular entity. In some such embodiments, an entity validation response may include one or more validation parameters that may indicate whether the particular entity in question is valid or invalid (e.g., Boolean value, a numeric value, a character, a string, and/or any other suitable value for indicating whether an entity is valid or invalid).

In some embodiments, S210 may function to permit or enable adding an entity node to the entity node cascade (e.g., by user input of a corresponding entity node ID into an entity node ID input field) only upon receiving an entity validation response indicating the corresponding entity of the entity node is valid. Additionally, or alternatively, in such embodiments, S210 may function to disable or otherwise prevent adding an entity node to the entity node cascade upon receiving an entity validation response indicating the corresponding entity of the entity node is invalid.

### 2.20 Configuring One or More Digital Activity Profile Artifacts

S220, which includes configuring one or more digital activity profile artifacts, may function to configure one or more digital activity profile artifacts based on user/subscriber input of one or more digital activity profile properties. In one or more embodiments, digital activity profile properties may include one or more user defined and/or user input data elements that may represent characteristics and/or values associated with a distinct digital activity. In some embodiments, S220 may function to automatically construct a digital activity profile artifact as a compound data structure that may include the one or more user/subscriber defined digital activity profile properties as data elements.

In one or more embodiments, the digital activity profile properties may include, but are not limited to, digital activity ID values (e.g., text label, textual summaries, activity ID numbers, and/or the like), digital activity initiator identifier values (e.g., text labels), routing prioritization identifiers, digital activity type identifiers or labels (e.g., a particular category or classification for a digital activity or task), digital activity geographical region identifying labels, digital activity temporal values (e.g., numerical time thresholds, time constraints, and/or the like), one or more textual summaries of one or more activities or tasks associated with the digital activity profile artifact, one or more user or entity identifying values (e.g., names, titles, ID numbers, and/or the like), and/or any other suitable values for identifying or characterizing an activity or task represented by the digital activity profile artifact.

### Digital Activity Profile Artifact User Interface

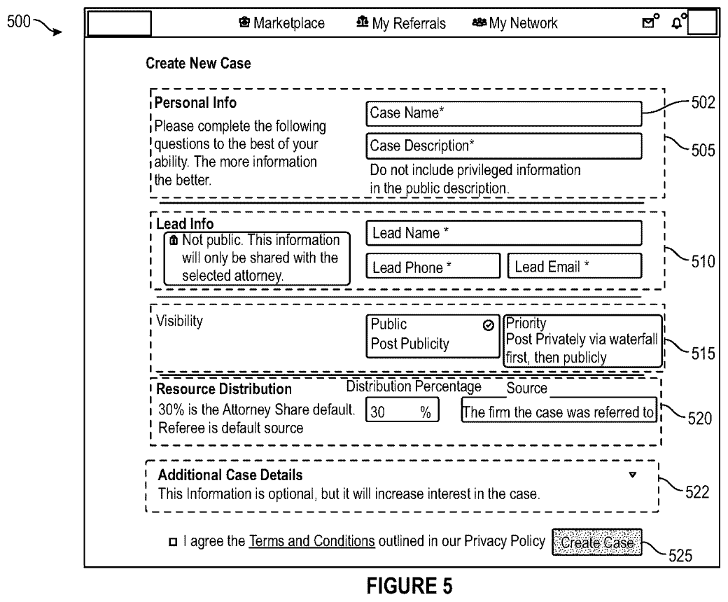

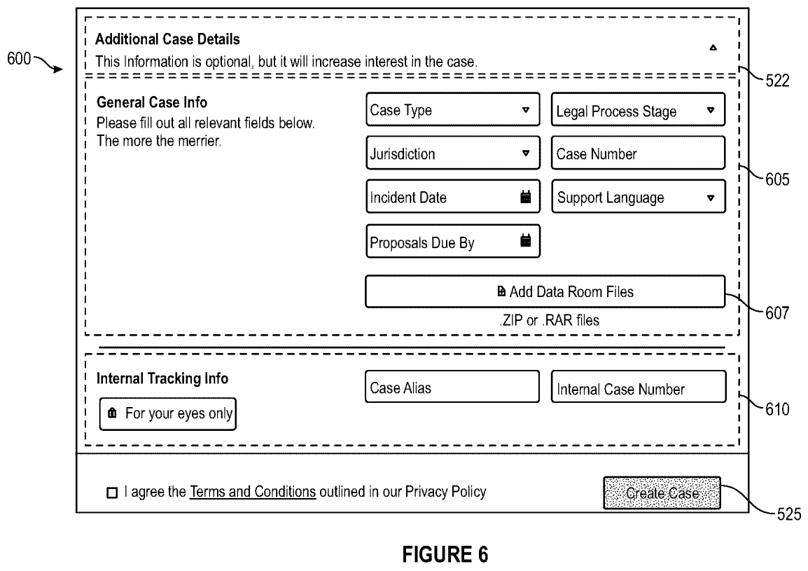

Preferably, the one or more digital activity profile artifacts may be constructed or otherwise configured based on user or subscriber input via a digital activity profile artifact user interface (sometimes referred to herein as the “digital activity artifact user interface”), as shown by way of example in FIGS. 5 and 6 (e.g., in user interfaces 500 and 600, which may represent multiple views of a same user interface). In one or more embodiments, the digital activity artifact user interface may be implemented as a graphical user interface (GUI). In some embodiments, the digital activity artifact user interface may be implemented in a same user interface instance and/or a same unified user interface as the cascade user interface (described in 2.10).

In one or more embodiments, the digital activity artifact user interface may include an interactive or selectable interface object (e.g., a button or the like) that may be interacted with (e.g., clicked, touched, toggled, and/or the like) that may function to initiate the construction of a new target digital activity profile artifact. A non-limiting example of the interactive or selectable interface object may include interactive or selectable interface object 525 of user interfaces 500 and 600. In some examples, upon interacting or selecting interactive or selectable interface object 525, container 701 of user interface 700 or 800 may be loaded (e.g., enabled, brought into view).

In one or more embodiments, the digital activity artifact user interface may include one or more digital activity profile property input fields (e.g., text input fields, numeric input fields, and/or the like) that may function to receive, as input, one or more user/subscriber input values (e.g., text strings, numeric values, characters, and/or the like) that may function to configure or define one or more corresponding digital activity profile properties of the target digital activity profile artifact. Various non-limiting examples of digital activity profile property input fields may be depicted within user interface display sections 505, 510, 520, 605, and 610 (e.g., digital activity profile property input field 502 of user interface display section 505).

Additionally, or alternatively, in some embodiments, the digital activity artifact user interface may include one or more digital activity profile data object fields that may function to receive, as input, one or more data objects (e.g., text data and/or text files, image data and/or image files, audio data and/or audio files, video data and/or video files, and/or any other suitable data objects and/or data object formats) that may function to describe, define, or otherwise characterize a digital activity of the target digital activity profile artifact. A non-limiting example of a digital activity profile data object field may be depicted within user interface display section 605 (e.g., digital activity profile data object field 607).

In some examples, the digital activity artifact user interface may include a user interface display section for configuring an identifier for the corresponding digital activity. For instance, in a non-limiting example, user interface 500 may include user interface display section 505 that may include a first digital activity profile property input field for configuring an identifier for the digital activity. Additionally, user interface display section 505 may include a second digital activity profile property input field for configuring a description of the digital activity.

In some examples, the digital activity user interface may include a user interface display section for configuring information about an entity associated with the digital activity (e.g., a lead). For instance, in a non-limiting example, user interface 500 may include user interface display section 510 that may include digital activity profile property input fields corresponding to an identifier for the entity and/or information that enables communication with the entity.

In some examples, the digital activity user interface may include a user interface display section for configuring whether the digital activity profile artifact is to initially be routed to an entity node nexus route that enables a discoverability of the digital activity profile artifact or the digital activity profile artifact is to initially be routed to an entity node cascade. For instance, in a non-limiting example, user interface 500 may include user interface display section 515 that may include interactive or selectable user interface control objects for selecting between initial routing to an entity node nexus route (e.g., a public route) or initial routing to an entity node cascade (e.g., a priority route). For instance, the user interface display section 515 may include a first interactive or selectable user interface control object for selecting initial routing to the entity node nexus route and a second user interface control object for selecting initial routing to an entity node cascade.

In some examples, the digital activity user interface may include a user interface display section for configuring information about resource distribution associated with the digital activity (e.g., a percentage of resources to be distributed, a distribution percentage) as well as an associated source. For instance, in a non-limiting example, user interface 500 may include user interface display section 520 that may include a first digital activity profile property input field for configuring a distribution percentage and a second digital activity profile property input field for configuring a source.

User interface 600 may be loaded (e.g., enabled, brought into view) by interacting with or selecting user interface control object 522. Upon loading user interface 600, user interface display sections 605 and 610 may be loaded (e.g., enabled, brought into view). User interface display section 605 may include digital activity profile property input fields for configuring additional information about the digital activity (e.g., locations associated with the digital activity, places associated with the digital activity, a type of the digital activity). Additionally, user interface display section 605 may include a digital activity profile data object field (e.g., digital activity profile data object field 607) for providing digital artifacts associated with the digital activity. Display section 610 may include digital activity profile property input fields for configuring internal or local identifiers (e.g., tracking information) for the digital activity.

### 2.30 Identifying an Entity Node Cascade for a Target Digital Activity Profile Artifact

S230, which includes identifying an entity node cascade for a target digital activity profile artifact, may function to selectively identify a distinct entity node cascade from among one or more entity node cascades that may be suitable for a target digital activity profile artifact. In turn, S230 may function to automatically associate the identified or selected distinct entity node cascade with the target digital activity profile artifact. Preferably, S230 may function to enable a user or subscriber to selectively search the one or more entity node cascades based on user input and/or one or more digital activity profile properties of the target digital activity profile artifact. In some embodiments, S230 may function to dynamically construct an entity node cascade for a target digital activity profile artifact.

### Selecting a Pre-Constructed Entity Node Cascade

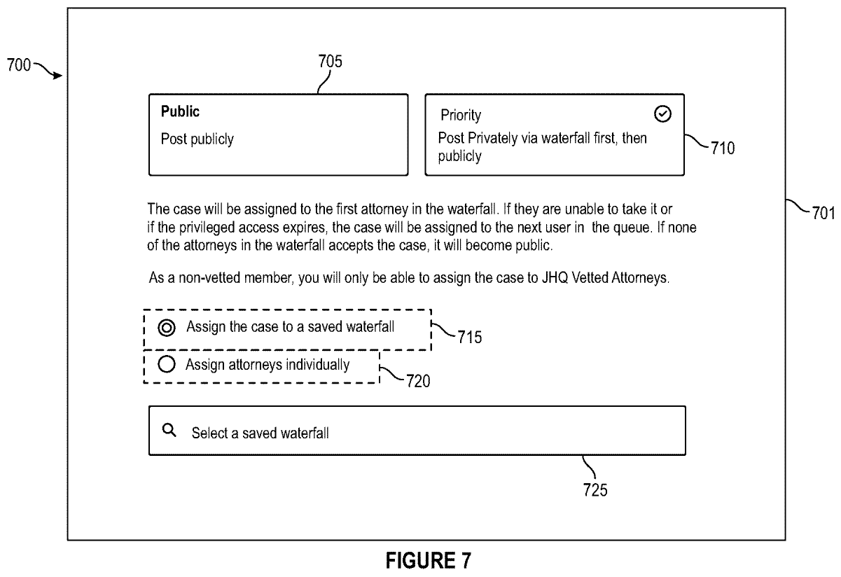

In some preferred embodiments, S230 may function to selectively identify a distinct entity node cascade to associate with a distinct target digital activity profile artifact from among one or more constructed entity node cascades based on user (or subscriber) input. In various embodiments, S230 may implement the digital activity profile artifact user interface (as described in 2.20) to receive user input for identifying and/or selecting the distinct entity node cascade for the target digital activity profile artifact, as shown by way of example in FIG. 7. In a first implementation, a user/subscriber may select a distinct entity node cascade from one or more distinct pre-constructed entity node cascades via one or more selectable interface control objects and/or one or more input fields in the digital activity profile artifact user interface. Additionally, or alternatively, in a second implementation, a user/subscriber may select a distinct entity node cascade from one or more distinct entity node cascades associated with the user/subscriber (e.g., from a list of stored or saved entity node cascades associated with the user/subscriber) via one or more selectable interface control objects and/or one or more input fields. In a third implementation, S230 may function to generate a search query and/or implement a search for a distinct entity node cascade from among one or more saved or stored entity node cascades. In such an implementation, S230 may function to generate a search query based on one or more user/subscriber input search criteria that may include one or more entity node cascade properties input into one or more cascade search input fields in the digital activity profile artifact user interface. In turn S230 may function to execute a search for one or more entity node cascades that may have properties that may relate to the input search criteria (e.g., searching based on entity node cascade ID, entity node cascade geographic region, and/or the like). It shall be noted that the above implementations may not be mutually exclusive, and in one or more embodiments S230 may include any suitable individual or combination of the above implementations. In a non-limiting example, user interface 700 may include an input field 725 (e.g., a search input field) that may be used as described herein to selectively identify the distinct entity node cascade.

In some embodiments, S230 identifying an entity node cascade for a target digital activity profile artifact may function or operate concurrently with S220 constructing the target digital activity profile artifact. That is, in some embodiments, a distinct entity node cascade may be identified and associated with the target digital activity profile artifact while the target digital activity profile artifact is being constructed (e.g., constructed via the digital activity profile artifact user interface as described in 2.20). Alternatively, in some embodiments, S230 may function or operate after (i.e., subsequent to) the construction of the target digital activity profile artifact. In such embodiments, S230 may function to enable an identification or selection of the distinct entity node cascade via the digital activity profile artifact user interface, such that a user or subscriber may configure or associate a pre-constructed target digital activity profile artifact with the distinct entity node cascade.

In one or more preferred embodiments, selecting or identifying a distinct entity node cascade may function to populate one or more entity node ID interface objects in the digital activity artifact user interface with one or more corresponding entity node IDs of the distinct entity node cascade. In some such embodiments, each of the entity node IDs of the distinct entity node cascade may be displayed or otherwise represented by one or more entity node ID interface objects in the distinct sequence of entity nodes defined by the entity node cascade. The distinct sequence may be represented visually in the user interface by a visual or graphical sequence of entity node ID interface objects (e.g., a top-to-bottom vertical sequential list, a left-to-right horizontal sequential list, and/or the like), and/or the distinct sequence may be represented by enumerators adjacent to or otherwise visually associated with the entity node ID interface objects (e.g., numerical enumerators such as 1, 2, 3, character enumerators such as A, B, C, and/or the like).

### Dynamic Entity Node Cascade Construction

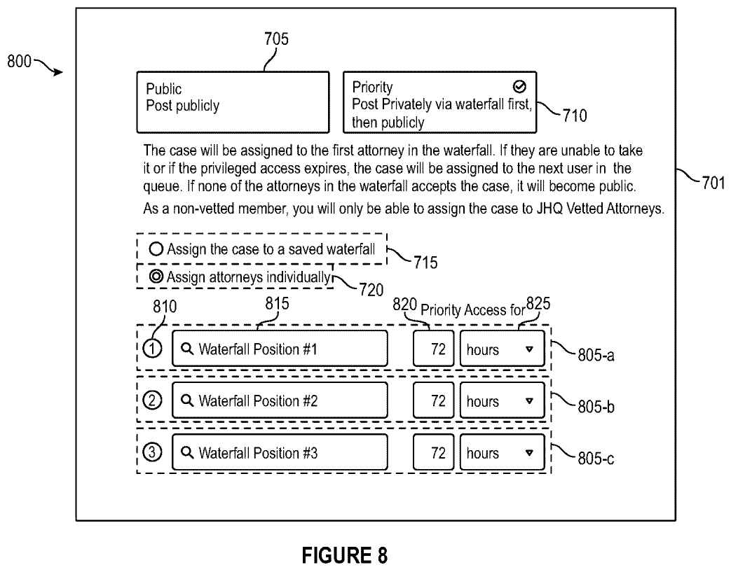

In some embodiments, S230 may function to dynamically construct an entity node cascade for a target digital activity profile artifact, and S230 may in turn function to automatically associate the dynamically constructed entity node cascade with the target digital activity profile artifact. In such embodiments, the dynamically constructed entity node cascade may function as the identified entity node cascade. In some such embodiments, a user (or subscriber) may select (e.g., via a selectable interface control object) dynamic entity node cascade construction in the digital activity profile artifact user interface. In one or more embodiments, S230 may enable user input of one or more entity node cascade properties for a dynamic construction of an entity node cascade via one or more entity node cascade property input fields in the digital activity profile artifact user interface, as shown by way of example in FIG. 8.

In a non-limiting example, user interfaces 700 and 800 may represent a same user interface in which a different entity node cascade property input field has been selected. For instance, user interface 700 may depict a user input to entity node cascade property input field 715 and user interface 800 may depict a user input to entity node cascade property input field 720, the latter of which may enable dynamic construction of the entity node cascade. It should be noted that selecting cascade property input field 715 may disable (e.g., delete, hide from view) entity node display sections 805-a, 805-b, and 805c and/or that selecting cascade property input field 720 may disable (e.g., delete, hide from view) input field 725.

Additionally, in one or more embodiments, S230 may enable user input of one or more entity node IDs via one or more corresponding entity node ID input fields. In some such embodiments, the distinct sequence of entity nodes of the dynamically constructed entity node cascade may be configured or defined by the visual or graphical sequential arrangement of entity node ID input fields, and/or by a sequence enumerator value (e.g., numeric enumerator values such as 1, 2, 3, etc., character enumerator values such as A, B, C, etc., and/or the like) associated with each entity node ID input field. In a non-limiting example, user interface 800 may include entity node display sections 805-a, 805-b, and 805-c, each of which may include a respective entity node ID input field 815. Each display section 05-a, 805-b, and 805-c may represent a respective entity node and may correspond to a particular ranking as indicated by the ranking identifier 810 in each display section. For instance, display section 805-a may have a highest priority ranking identifier 810, display section 805-b may have a next highest priority ranking identifier 810, and display section 805-c may have a lowest priority ranking identifier 810. The entity node with the highest ranking identifier 810 may be the first entity node to which a digital activity profile artifact is to be routed, the entity node with the next highest ranking identifier 810 may be the second entity node to which a digital activity profile artifact is to be routed, and so on.

As a non-limiting example, while providing input to construct a target digital activity profile artifact (e.g., via S220), a user may elect to dynamically construct an entity node cascade for a target digital activity profile artifact. In such an example, the digital activity profile artifact user interface may include an entity node cascade ID input field to receive input of an entity cascade ID label (e.g., a title, name, or other text identifier). Additionally, in such an example, the digital activity profile artifact user interface may include a plurality of entity node ID input fields (e.g., entity node ID input fields that may function as described in 2.10). It shall be noted that, as described in 2.10, each entity node ID input field may additionally or alternatively function as a search input field that may enable a search query or search functionality for an entity node. Additionally, in such an example, each entity node ID input field may be associated with a corresponding sequence enumerator that may function to identify a position of the associated entity node ID in an entity node sequence. In such an example, a user may function to input a distinct entity node ID value in each entity node ID input field, whereby each input entity node ID value may represent a corresponding entity node to be included in the dynamically constructed entity node cascade. In such an example, S230 may function to identify user input (e.g., by selecting or interacting with a corresponding selectable interface object) that may function to trigger a dynamic construction of an entity node cascade based on the current values in the entity node ID input fields and the current value(s) of the entity node cascade ID input field. In such an example, a visual or graphical sequential arrangement of the entity node ID input fields (e.g., vertical top-to-bottom arrangement, horizontal left-to-right arrangement, and/or the like), and/or the sequence enumerators associated with each entity node ID input field may function to define the distinct sequence of entity nodes for the dynamically constructed entity node cascade. Accordingly, S230 may function to encode the dynamically constructed entity node cascade with the defined distinct sequence of entity nodes.

In some examples, user interfaces 700 and 800 may include one or more user interface control objects for selecting between whether the digital activity profile artifact is to initially be routed to an entity node nexus route that enables a discoverability of the digital activity profile artifact or the digital activity profile artifact is to initially be routed to an entity node cascade. For instance, user interfaces 700 and 800 may include a first user interface control object 705 for selecting that the digital activity profile artifact is to be initially routed to the entity node nexus route and a second user interface control object 710 for selecting that the digital activity profile artifact is to initially be routed to an entity node cascade. If the first user interface control object 705 is selected, one or more user interface elements of container 701 (e.g., entity node cascade property input fields 715 and 720, input field 725, user interface display sections 805-a, 805-b, and 805-c) may be disabled (e.g., deleted, hidden from view). If the second user interface control object 710 is selected, the one or more user interface elements of container 701 may be enabled (e.g., loaded, brought into view).

### Configuring Temporal Thresholds

In some preferred embodiments, S230 may additionally, or alternatively, function to configure one or more temporal thresholds for the identified (or dynamically constructed) entity node cascade. In such preferred embodiments, each entity node identified in the entity node cascade may be associated with a distinct temporal threshold, such that a number of temporal thresholds may be equivalent to a number of entity nodes in the entity node cascade. As generally referred to herein, a temporal threshold associated with a distinct entity node may relate to a temporal constraint or limit value (e.g., a time limit, an expiration timestamp, timer, and/or the like) that may identify an amount of time that may elapse before the target digital activity artifact is routed or transmitted to a subsequent entity node in the sequence defined by the entity node cascade.

In some embodiments, S230 may function to configure the one or more temporal thresholds based on user input of one or more temporal threshold values. In such embodiments, the digital activity profile artifact user interface may include one or more temporal threshold value input fields (e.g., numerical and/or text input fields) that may function to enable user input of numerical and and/or text-based temporal values (e.g., a number of seconds, minutes, hours, days, and/or the like). Additionally, or alternatively, the digital activity profile artifact user interface may include one or more temporal threshold value selectable interface objects (e.g., one or more dropdown lists, radio buttons checkboxes, toggle switches, and/or the like) that may function to enable user selection of one or more temporal threshold values and/or one or more temporal threshold value modifiers (e.g., units of time, temporal period identifiers such as “minutes,” “hours,” “days,” “weeks,” and/or the like). In a non-limiting example, user interface display sections 805-a, 805-b, and 805-c of user interface 800 may each have a respective temporal threshold value input field 820 and temporal threshold value selectable interface object 825 corresponding to their respective entity node ID input field 815.

As a non-limiting example, the digital activity profile artifact user interface may include, for each entity node in the identified entity node cascade, a temporal threshold value input field that may receive a numerical value user input and a temporal threshold value selectable interface object that may enable user selection of a temporal period. In such an example, S230 may function to configure a temporal threshold for each entity node based on the user input in the corresponding threshold value input field and the user selection of a temporal period. For example, for a given entity node, a user input of “24” in the corresponding threshold value input field and a user selection of “hours” in the corresponding threshold value selectable interface object may define a temporal threshold of 24 hours for the corresponding entity node.

It shall be noted that, in some embodiments, each entity node in an entity node cascade may be associated with a distinct temporal threshold, such that each entity node may be associated with a distinct unique temporal threshold that may or may not be equivalent to the temporal thresholds of other entity nodes of the same entity node cascade.

### 2.40 Executing a Scheduled Sequential Routing of the Target Digital Activity

Profile Artifact based on the Identified Entity Node Cascade S240, which includes executing a scheduled sequential routing of the target digital activity profile artifact based on the identified entity node cascade, may function to initiate and/or execute one or more routings of the target digital activity profile artifact to one or more target entity nodes based on the distinct entity node sequence defined by the identified entity node cascade. Preferably, S240 may function to identify one or more entity nodes based on the sequential structure defined by the identified entity node cascade, and in turn S240 may function to automatically transmit a digital activity profile query or request to each entity node of the sequential structure in an automated scheduled sequence until a confirmation response is received from a queried entity node.

### Scheduled Sequential Routing Initiation

Preferably, S240 may function to execute a scheduled sequential routing of the target digital activity profile artifact based on the identified entity node cascade. In some preferred embodiments, S240 may function to initiate the scheduled sequential routing of the target digital activity profile artifact automatically in response to identifying (or dynamically constructing) the entity node cascade associated with the target digital activity profile artifact. Alternatively, S240 may function to initiate the scheduled sequential routing based on receiving user input confirming or indicating a user intent to execute the scheduled sequential routing.

### Digital Activity Profile Query Generation

In some preferred embodiments, S240 may function to generate or construct a digital activity profile query (sometimes referred to herein as an activity query) that may include the target digital activity profile artifact and a response-enabled prompt or electronic communication. In such embodiments, the scheduled sequential routing of the target digital activity profile artifact may be encompassed by a scheduled sequential routing or transmission of the digital activity profile query to one or more target entity nodes. In some such embodiments, the response-enabled prompt or electronic communication may include one or more pieces of activity-descriptive data (e.g., text data, numeric data, image data, audio data, video data, and/or the like) that may facilitate a description of one or more activities or tasks of the target digital activity artifact.

In some embodiments, the response-enabled prompt or electronic communication may include one or more selectable interface objects embedded in the prompt or communication that may function to enable or permit a response confirming or rejecting the target digital activity artifact from one or more entities associated with a target entity node. In such embodiments, S240 may function to receive the response from the one or more entities of the target node by a same communication channel used to route the digital activity profile query to the target node. Additionally, or alternatively, S240 may function to receive the response from the one or more entities of the target node by a different communication channel. In various embodiments, S240 may function to transmit, route, and/or receive data by implementing and/or using one or more communication channels including, but not limited to, email communication channels, SMS communication channels, third-party messaging or communication channels, and/or the like.

### Scheduled Sequential Routing

In one or more preferred embodiments, the scheduled sequential routing of the target digital activity artifact or profile query may be defined or governed by the entity node sequence of the identified entity node cascade and/or the one or more temporal thresholds associated with the one or more entity nodes of the entity node cascade. Accordingly, S240 may function to implement the scheduled sequential routing to orchestrate an automated systematic transmission of digital activity profile queries or artifacts from one entity node to the subsequent entity node within the entity node sequence.

In one or more preferred embodiments, S240 may function to initially route the target digital activity artifact or profile query to the initial entity node in the entity node sequence of the identified entity node cascade. S240 may then function to hold execution of the scheduled sequential routing, preventing any subsequent transmission or routing of the target digital activity artifact or profile query, until either a) a response is received from one or more entities associated with the initial entity node (e.g., via the response-enabled prompt or communication) or b) the temporal threshold associated with the initial entity node is met or exceeded. If S240 identifies a confirmation response indicating a confirmation from one or more entities of the initial entity node, S240 may function to terminate execution of the scheduled sequential routing. If S240 identifies a rejection response indicating a rejection from one or more entities of the initial entity node, and/or if S240 determines that the temporal threshold associated with the initial entity node has been met or exceeded, S240 may function to continue an execution of the scheduled sequential routing by initiating a routing or transmission of the target digital activity artifact or profile query to the successive or subsequent entity node in the entity node sequence of the identified entity node cascade. S240 may function to continue to iteratively execute the scheduled sequential routing on subsequent nodes until either a) at least one entity provides a confirmation response or b) the temporal threshold of the last entity node of the entity node sequence is met or exceeded, after which S240 may function to terminate execution of the scheduled sequential routing.

As a non-limiting example, upon initiation of a scheduled sequential routing in an entity node cascade including three entity nodes, S240 may function to transmit or route the digital activity profile query or artifact to the first entity node in the entity node sequence of the entity node cascade. S240 may then function to pause or hold any subsequent routing or continued execution of the scheduled sequential routing until the temporal threshold associated with the first entity node has been met or exceeded, or a response is received from the one or more entities associated with the first entity node. In turn, once S240 determines that the temporal threshold associated with the first entity node has been met or exceeded and no confirmation response has been received, or that a rejection response has been received, S240 may function to transmit or route the digital activity profile query or artifact to the second entity node in the entity node sequence of the entity node cascade, and S240 may then function to pause or hold subsequent routing or continued execution of the scheduled sequential routing until the temporal threshold associated with the second entity node has been met or exceeded, or a response is received from the one or more entities associated with the second entity node. In turn, once S240 determines that the temporal threshold associated with the second entity node has been met or exceeded and no confirmation response has been received, or that a rejection response has been received, S240 may function to transmit or route the digital activity profile query or artifact to the third entity node in the entity node sequence of the entity node cascade, and S240 may then function to pause or hold subsequent routing or continued execution of the scheduled sequential routing until the temporal threshold associated with the third entity node has been met or exceeded, or a response is received from the one or more entities associated with the third entity node. In turn, once S240 determines that the temporal threshold associated with the third entity node has been met or exceeded and no confirmation response has been received, or that a rejection response has been received, S240 may function to terminate execution of the scheduled sequential routing. In such an instance, S240 may function to determine that the scheduled sequential routing has failed to identify a confirmation response for the target digital activity artifact from the entity nodes in the entity node cascade. Additionally, in such an example, if S240 determines that a confirmation response from a queried entity has been received during the timespan defined by the temporal threshold associated with the queried entity, S240 may function to terminate execution of the scheduled sequential routing. In such an instance, S240 may function to determine that the scheduled sequential routing has successfully identified a confirmation response for the target digital activity artifact from an entity node in the entity node cascade.

### Temporal Threshold Evaluation

Preferably, upon routing the digital activity profile query or artifact to an entity node, S240 may function to evaluate the temporal threshold associated with the entity node to determine when the scheduled sequential routing may be continued. In a first implementation, upon a routing or transmission of the digital activity profile query or artifact to an entity node, S240 may function to initiate a countdown timer value based on the temporal threshold (e.g., a countdown timer with a value equal to the temporal threshold). In such implementations, the countdown timer may be decremented and updated for each temporal period elapsed (e.g., every second, minute, hour, day, or the like) since the initiation of the timer. In such implementations, S240 may function to evaluate the countdown timer on every decrement or update, and upon reaching zero S240 may function to restart or continue execution of the scheduled sequential routing.

In a second implementation, upon a routing or transmission of the digital activity profile query or artifact to an entity node, S240 may function to initiate a counter value with an initial value of zero. In such an implementation, the counter may be incremented and updated for each temporal period elapsed (e.g., every second, minute, hour, day, or the like) since the initiation of the timer. In such implementations, S240 may function to evaluate the counter value relative to the temporal threshold on every increment or update. In such implementations, when S240 determines that the counter value is greater than or equal to the temporal threshold (i.e., the time elapsed meets or exceeds the temporal threshold), S240 may function to restart or continue execution of the scheduled sequential routing.

In a third implementation, upon a routing or transmission of the digital activity profile query or artifact to an entity node, S240 may function to configure or set a routing start timestamp value that may relate to the datetime at which the digital activity profile query or artifact may have been routed or transmitted to the entity node. In such an implementation, S240 may function to periodically and/or continuously compute an elapsed time value based on comparing a current datetime to the routing start timestamp value (e.g., by subtracting the routing start timestamp value from the current datetime in equivalent temporal units). In such implementations, S240 may function to evaluate or compare the elapsed time value relative to the temporal threshold upon every computation update. In such implementations, when S240 determines that the elapsed time value is greater than or equal to the temporal threshold (i.e., the temporal threshold has been met or exceeded), S240 may function to restart or continue execution of the scheduled sequential routing.

In a fourth implementation, upon a routing or transmission of the digital activity profile query or artifact to an entity node, S240 may function to configure or set a routing restart timestamp value that may relate to the datetime at which the scheduled sequential routing should be restarted or continued. In such an implementation, S240 may function to compute the routing restart timestamp value based on the datetime at which the digital activity profile query or artifact may have been routed or transmitted to the entity node and the temporal threshold (e.g., by adding the routing datetime and the temporal threshold in equivalent temporal units). In such implementations, S240 may function to periodically or continuously evaluate or compare the routing restart timestamp value relative to the current datetime. In such implementations, when S240 determines that the current datetime is greater than or equal to the routing restart timestamp value (i.e., the temporal threshold has been met or exceeded), S240 may function to restart or continue execution of the scheduled sequential routing.

### User Notification of Termination of the Scheduled Sequential Routing

In some embodiments, S240 may function to notify one or more users or subscribers associated with a target digital activity artifact when the scheduled sequential routing of the target digital activity artifact has been terminated. In such embodiments, if the scheduled sequential routing has been terminated based on identifying and/or receiving a confirmation response from one or more entities, S240 may function to transmit a routing success notification to the one or more users or subscribers. In such embodiments, the routing success notification may include one or more pieces of descriptive data relating to the one or more entities or an associated entity node (e.g., entity names, entity titles, entity node IDs, entity node profiles, and/or any other suitable data that may describe an entity).

Additionally, or alternatively, in some embodiments, if the scheduled sequential routing has been terminated without receiving a confirmation response from one or more entities, S240 may function to transmit a routing failure notification to the one or more users or subscribers. In such embodiments, the routing failure notification may include any or all rejection responses received or identified by S240 during the scheduled sequential routing of the target digital activity profile artifact or profile query.

Additionally, or alternatively, in some embodiments, if the scheduled sequential routing has been terminated without receiving a confirmation response from one or more entities, S240 may function to initiate a routing of the target digital activity profile artifact or profile query to an entity node nexus route that may enable a discoverability of the target digital activity profile artifact or profile query by one or more entities represented by one or more entity nodes in the entity node nexus. In some such embodiments, S240 may function to automatically initiate the routing of the target digital activity profile artifact to the entity node nexus route based on terminating the scheduled sequential routing without receiving a confirmation response from one or more entities. Alternatively, in some embodiments, S240 may function to initiate the routing of the target digital activity profile artifact to the entity node nexus route based on user/subscriber input confirming an intent to route the target digital activity profile artifact to the entity node nexus route.

### 2A. Method for Intelligently Routing Digital Activity Profile Data in an Automated Scheduled Cascade

As shown in FIG. 2A, a method 200A for intelligently routing digital activity profile data in an automated scheduled cascade includes receiving, via a network, one or more cascading parameters and inputs for constructing a cascading data packet and identifying a set of networked entity nodes arranged in a defined order S210A; configuring, by a microservice, the cascading data packet based on the cascading parameters 220A; storing, to a memory, the cascading data packet and the configuration of the cascading data packet 230A; and transmitting, from the memory and via the network, the cascading data packet to a first networked entity node of the set of networked entity nodes 240A.

One of ordinary skill in the art will appreciate that method 200A offers significant technical advantages and practical benefits over other data packet routing methods. In other methods, users must manually track and direct data packets, deciding which entity nodes to send them to and when to perform each routing step. This manual configuration may lead to inconsistencies, delays, and a higher potential for human error. In contrast, the invention described here enables fully automated routing, removing the need for constant user involvement and reducing the chance of errors associated with manual tracking.

Additionally, the automated routing process may be further enhanced by an intuitive user interface, such as a graphical user interface (GUI), which simplifies setup and management. The interface allows users to easily store and reuse information about entity nodes and their sequences, streamlining the routing configuration process. Additionally, the interface guides users through the routing setup without requiring any script-based commands, significantly lowering the technical demands and making it accessible to users without specialized knowledge. This design reduces technical overhead and ensures a smooth, efficient routing process with minimal user input.

### 2.10A Receiving Cascading Parameters and Inputs

S210A, which includes receiving information via a network, may function to receive one or more cascading parameters and inputs for constructing a cascading data packet and identifying a set of networked entity nodes arranged in a defined order. A cascading data packet may be a data packet with scheduled sequential routing that includes a digital activity profile artifact. The set of networked entity nodes may refer to entity nodes of an entity node cascade, and the set of networked entity nodes being arranged in the defined order may refer to the set of networked entity nodes having an entity node sequence.

The inputs received at S210 may include one or more first inputs for constructing a cascading data packet and one or more second inputs identifying a set of networked entity nodes arranged in a defined order. The one or more first inputs for constructing the cascading data packet may refer to user input (e.g., via a user interface) that enables construction of the cascading data packet (e.g., user input requesting the construction of a cascading data packet). For instance, the one or more first inputs may include user input received via an interactive or selectable interface object of an entity node cascade user interface as described herein (e.g., via interactive or selectable interface object 320 of user interface 300). Additionally, or alternatively, the one or more first inputs may include user input received via the digital activity profile artifact user interface (e.g., signaling confirming a user input to input field 725 and/or to each of entity node ID input field 815). The one or more second inputs identifying the set of networked entity nodes arranged in the defined order may refer to user input (e.g., via a user interface) identifying entity nodes of an entity node cascade. For instance, the one or more second inputs may include user input received via an input field (e.g., via entity node ID input fields 315-a, 315-b, and 315-c of user interface 300, input field 725 of user interface 700, or entity node ID input field 815 of user interface 800).

The one or more cascading parameters may be for generating dynamic routing instructions for dynamically routing the cascading data packet across a network of entity node accounts. The one or more cascading parameters may include routing sequencing parameters and one or more temporal threshold parameters. The routing sequencing parameters may refer to parameters received via user input (e.g., via user input to a user interface) used for encoding a set of dynamic routing instructions. For instance, the routing sequencing parameters may include an order of the sequence of entity nodes input to entity node ID input fields (e.g., entity node ID input field 315-a or entity node ID input field 815 of entity node display section 805-a representing a first entity node in the sequence, entity node ID input field 315-b or entity node ID input field 815 of entity node display section 805-b representing a second entity node in the sequence, entity node ID input field 315-c or entity node ID input field 815 of entity node display section 805-c representing a third entity node in the sequence). The one or more temporal threshold parameters may refer to parameters received via user input (e.g., via user input to a user interface) used for encoding temporal thresholds. For instance, the temporal threshold parameters may include parameters configured via user input to temporal threshold value input fields and/or temporal threshold value selectable interface objects (e.g., temporal threshold value input field 820 and/or temporal threshold value selectable interface object 825).

### Reception of Cascading Parameters and Inputs Via a User Interface

In some examples, the dynamic data packet routing service may provide, to a user interface, one or more first user interface input elements. The one or more first user interface elements may be editable to indicate two or more networked entity nodes. For instance, the dynamic data packet routing service may provide, to an entity node cascade user interface, entity node ID input fields (e.g., entity node ID input fields 315-a, 315-b, and 315-c) Additionally, or alternatively, the dynamic data packet routing service may provide, to a digital activity profile artifact user interface, input fields (e.g., input field 725 and/or entity node ID input fields 815). The one or more inputs identifying the set of networked entity nodes arranged in the defined order may include a first user input being applied to the one or more first user interface input elements. In some examples, receiving the routing sequencing parameters may be based on the first user input being applied to the one or more first user interface input elements. For instance, the routing sequencing parameters may include an order of the sequence of entity nodes input to entity node ID input fields which may be provided to dynamic data packet routing service along with the information input to the entity node ID input fields.

In some examples, the dynamic data packet routing service may provide, to a user interface, one or more second user interface input elements, the one or more second user interface input elements editable to indicate one or more temporal thresholds. For instance, the dynamic data packet routing service may provide, to a digital activity profile artifact user interface, temporal threshold value input fields and/or temporal threshold value selectable interface objects (e.g., temporal threshold value input field 820 and/or temporal threshold value selectable interface object 825) The one or more temporal threshold parameters may be received based on a second user input being applied to the one or more second user interface input elements.

### 2.20A Configuring a Cascading Data Packet

S220A, which includes configuring, by a microservice, the cascading data packet based on the cascading parameters may function to encode a set of dynamic routing instructions and a set of temporal thresholds for the cascading data packet. For instance S220A configuring the cascading data packet may include S220A encoding for the cascading data packet a set of dynamic routing instructions that, when executed causes an automated routing of the cascading data packet along one or more entity nodes of the set of networked entity nodes in an order predefined by the routing sequencing parameters. Dynamic routing instructions may relate to the logic performed by the dynamic data packet routing service in order to execute scheduled sequential routing for a digital activity profile artifact (e.g., a cascading data packet including a digital activity profile artifact) according to the sequence of distinct entity nodes defined for an entity node cascade. The routing being automated may relate to re-routing occurring by the dynamic data packet routing service without additional user input once the cascading data packet is routed to an initial networked entity node. The order being predefined by the routing sequencing parameters may relate to the order of entity nodes as defined by the corresponding sequence.

Additionally, S220A configuring the cascading data packet may include S220A encoding for the cascading data packet, a set of temporal thresholds that sets a temporal limit for each instance of a routing of the cascading data packet to a respective entity node of the set of networked entity nodes based on the one or more temporal threshold parameters. A temporal limit may relate to a temporal value at which a respective temporal threshold of the set of temporal thresholds is satisfied or crossed. The temporal limit, when satisfied, may cause an automatic re-routing of the cascading data packet from a current entity node of the set of networked entity nodes to a subsequent entity node of the set of networked entity nodes that follows the current entity node within the defined order. The set of temporal thresholds being set based on the one or more temporal threshold parameters may relate to the one or more temporal threshold parameters indicating values for the set of temporal thresholds and the dynamic data packet routing service setting the set of temporal thresholds to the indicated values.

### 2.30A Storing the Cascading Data Packet and its Configuration

S230A, which includes storing, to a memory, the cascading data packet and the configuration of the cascading data packet may function to provide information to the memory that enables the dynamic data packet routing service to monitor and transmit the cascading data packet. Storing the cascading data packet and the configuration of the cascading data packet may include storing data related to digital activity profile artifacts and corresponding entity node cascades (e.g., the sequence of entity nodes in each entity node cascade and the temporal threshold for each entity node in the entity node cascade) at a data repository as described herein. In some examples, the storing of the cascading data packet and the configuration of the cascading data packet may occur upon a user selectively identifying a distinct entity node cascade for a target digital activity profile artifact as described herein.

### 2.40A Transmitting the Cascading Data Packet

S240A, which includes transmitting the cascading data packet to a first networked entity node of the set of networked entity nodes may function to initiate automated routing of the cascading data packet in response to an input for launching the cascading data packet. The first networked entity node to which a cascading data packet may be sent may be a first entity node in a corresponding sequence (e.g., a first networked entity node as defined in the order). The input for launching the cascading data packet may include user input. For instance, upon a user selectively identifying a distinct entity node cascade as described herein, a target digital activity profile artifact (e.g., a cascading data packet including a target digital activity profile artifact) may be transmitted.

### Networked Entity Node Data Structure

In some examples, the dynamic data packet routing service may generate, based on the one or more inputs identifying the networked entity nodes arranged in the defined order, a data structure. Additionally, the dynamic data packet routing service may store, in the data structure, information that indicates each networked entity node in the set of network entity nodes and the defined order in which the set of networked entity nodes is arranged. For instance, the dynamic data packet routing service may generate a sequential data structure (e.g., a matrix, array, table, and/or the like) that includes one or more respective entity node identifiers (e.g., entity node identifying values or labels) for the networked entity nodes. The entity node identifying values or labels may be arranged in a distinct pattern within the data structure that indicates the defined order or may each be linked to (e.g., in a same row, a same class, a same object) a respective indicator indicating a ranking for a particular entity node relative to other entity nodes.

After storing the information in the data structure, the dynamic data packet routing service may provide, via the network, signaling indicating that the information has been successfully stored in the data structure. In a non-limiting example, after user input is provided to the interactive or selectable interface object 320, dynamic data packet routing service may store the information input to node entity ID input fields 315-a, 315-b, and 315-c in a data structure. Once the information is stored in the data structure, the dynamic data packet routing service may provide signaling indicating that the information has been successfully stored. For instance, user interface 300 may be disabled (e.g., deleted, hidden from view) and user interface 400 may include a new interface element that corresponds to the stored information (e.g., an interface element corresponding to a new entity node cascade).

In some examples, the dynamic data packet routing service may receive, via the network, an identifier for the data structure or one or more identifiers for the set of networked entity nodes. For instance, in a non-limiting example, when a user provides a user input to input field 725 of user interface 700, an identifier for the data structure (e.g., an entity node cascade ID) or one or more identifiers for the set of networked entity nodes (e.g., entity node IDs) may be provided to the dynamic data packet routing service.

After receiving the identifier for the data structure or the one or more identifiers for the set of networked entity nodes, the dynamic data packet routing service may compare the received identifier for the data structure with a stored identifier of the data structure or the received one or more identifiers for the set of networked entity nodes with one or more stored identifiers of the set of networked entity nodes. For instance, in a non-limiting example, the dynamic data packet routing service may compare a received entity node cascade ID with a stored entity node cascade ID or may compare one or more received entity node IDs with the stored entity node IDs.

Based on the comparing, the dynamic data packet routing service may select the data structure, where S240A may transmit the cascading data packet based on the selecting. For instance, in a non-limiting example, the dynamic data packet routing service may select the entity node cascade whose received entity node cascade ID matches a corresponding stored entity node cascade ID or may select the entity node cascade whose entity nodes have entity node IDs that match the received entity node IDs. The dynamic data packet routing service may then provide an indication of the selected entity node cascade to user interface 700, which may provide one or more user interface display elements to display the indication of the selected entity node cascade. The user may then select a particular entity node cascade, which may enable configuration of a cascading data packet.

### Counters for Cascading Data Packet Routing

In some examples, the dynamic data packet routing service may initialize a counter for a first temporal threshold of the set of temporal thresholds. For instance, the dynamic data packet routing service may start a counter that tracks whether the first temporal threshold has been satisfied after transmitting the cascading data packet. The first temporal threshold may be for the first network entity node of the set of networked entity nodes. For instance, the first temporal threshold may correspond to an initial entity node to which a cascading data packet is routed.

In some examples, the dynamic data packet routing service may store a value of the counter to the memory. The dynamic data packet routing service may store the counter to the memory to track whether the temporal threshold has been satisfied. For instance, the dynamic data packet routing service may compare a value of the counter stored at the memory to the first temporal threshold to determine if the temporal threshold has been satisfied. Each time the dynamic data packet routing service performs the comparison, the dynamic data packet routing service may update a value of the counter at the memory if the value of the counter does not satisfy the temporal threshold. However, if the value of the counter satisfies the temporal threshold, the dynamic data packet routing service may disable (e.g., delete, reset) the counter.

### Confirmation of the Cascading Data Packet

In some examples, the dynamic data packet routing service may receive, from the first networked entity node, a response data packet, the response data packet indicating an approval by the first networked entity node. For instance, the response data packet may include a message that indicates a confirmation or approval by the entity associated with the first networked entity node. Additionally, the dynamic data packet routing service may terminate the automated routing of the cascading data packet to any other networked entity node of the set of networked entity nodes based on the response data packet indicating the approval by the first networked entity node. For instance, the dynamic data packet routing service may refrain from providing additional instances of the cascading data packet to other networked entity nodes of the set of networked entity nodes. In some examples, the dynamic data packet routing service may disable (e.g., delete, reset) the counter as part of terminating the automated routing.

### Rejection of the Cascading Data Packet

In some examples, the dynamic data packet routing service may receive, from the first networked entity node, a response data packet, the response data packet indicating a rejection by the first networked entity node. For instance, the response data packet may include a message that indicates a rejection by the entity associated with the first networked entity node. The dynamic data packet routing service may route the cascading data packet to a second networked entity node of the set of networked entity nodes based on the response data packet indicating the rejection by the first networked entity node. For instance, after receiving the response data packet indicating the rejection, the dynamic data packet routing service may provide, to the network, a next instance of the cascading data packet for the second networked entity node. The next instance of the cascading data packet may have a separate header from the initial cascading data packet that indicates that it is to be routed to the second entity node (e.g., instead of the first entity node).

The dynamic data packet routing service may initialize a second counter for a second temporal threshold of the set of temporal thresholds based on the response data packet indicating the rejection by the first networked entity node. For instance, the dynamic data packet routing service may start a counter that tracks whether the second temporal threshold has been satisfied after transmitting the next cascading data packet. The second temporal threshold may be for the second network entity node of the set of networked entity nodes. For instance, the second temporal threshold may correspond to an initial entity node to which a cascading data packet is routed. The dynamic data packet routing service may disable (e.g., delete, reset) the first counter for the first temporal threshold based on the response data packet indicating the rejection by the first networked entity node.

### Routing of the Cascading Data Packet Due to Satisfying a Temporal Threshold

In some examples, the dynamic data packet routing service may determine that the first temporal threshold has been reached without receiving a response data packet from the first entity node. For instance, the dynamic data packet routing service may determine that the value of the counter has satisfied or exceeded the first temporal threshold. The dynamic data packet routing service may route the cascading data packet to a second networked entity node of the set of networked entity nodes based on determining that the first temporal threshold has been reached. For instance, after determining that the first temporal threshold has been reached, the dynamic data packet routing service may provide, to the network, a next instance of the cascading data packet for the second networked entity node. The next instance of the cascading data packet may have a separate header from the initial cascading data packet that indicates that it is to be routed to the second entity node (e.g., instead of the first entity node).

The dynamic data packet routing service may initialize a second counter for a second temporal threshold of the set of temporal thresholds based on determining that the first temporal threshold has been reached. For instance, the dynamic data packet routing service may start a counter that tracks whether the second temporal threshold has been satisfied after transmitting the next cascading data packet. The second temporal threshold may be for the second network entity node of the set of networked entity nodes. For instance, the second temporal threshold may correspond to an initial entity node to which a cascading data packet is routed. The dynamic data packet routing service may disable (e.g., delete, reset) the first counter for the first temporal threshold based on the response data packet indicating the rejection by the first networked entity node.

### 3. Computer-Implemented Method and Computer Program Product

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A computer-implemented method comprising:
at a dynamic data packet routing service:
receiving, via a network:
one or more inputs for constructing a cascading data packet;
one or more inputs identifying a plurality of networked entity nodes arranged in a defined order; and
one or more cascading parameters for generating dynamic routing instructions for dynamically routing the cascading data packet across a network of entity node accounts, wherein the one or more cascading parameters include (a) routing sequencing parameters and (b) one or more temporal threshold parameters;
configuring, by a microservice of the dynamic data packet routing service, the cascading data packet based on the one or more cascading parameters, wherein configuring the cascading data packet includes:
encoding for the cascading data packet a set of dynamic routing instructions that, when executed, causes an automated routing of the cascading data packet along one or more entity nodes of the plurality of networked entity nodes in an order predefined by the routing sequencing parameters;
encoding for the cascading data packet a set of temporal thresholds that sets a temporal limit for each instance of a routing of the cascading data packet to a respective entity node of the plurality of networked entity nodes based on the one or more temporal threshold parameters, wherein the temporal limit, when satisfied, causes an automatic re-routing of the cascading data packet from a current entity node of the plurality of networked entity nodes to a subsequent entity node of the plurality of networked entity nodes that follows the current entity node within the defined order;
storing to a memory the cascading data packet and the configuration of the cascading data packet; and
transmitting from the memory, via the network, the cascading data packet to a first networked entity node of the plurality of networked entity nodes in response to an input for launching the cascading data packet.

2. The computer-implemented method according to claim 1, further comprising:
at the dynamic data packet routing service further:
generating, based at least in part on the one or more inputs identifying the plurality of networked entity nodes arranged in the defined order, a data structure;
storing, in the data structure, information that indicates each networked entity node in the plurality of networked entity nodes and the defined order in which the plurality of networked entity nodes is arranged; and
providing, via the network, signaling indicating that the information has been successfully stored in the data structure.

3. The computer-implemented method according to claim 2, the method further comprising:
at the dynamic data packet routing service further:
receiving, via the network, an identifier for the data structure or one or more identifiers for the plurality of networked entity nodes;
comparing the received identifier for the data structure with a stored identifier of the data structure or the received one or more identifiers for the plurality of networked entity nodes with one or more stored identifiers of the plurality of networked entity nodes; and
selecting the data structure based at least in part on the comparing, wherein transmitting the cascading data packet is based at least in part on the selecting.

4. The computer-implemented method according to claim 2, wherein the information indicating each networked entity node in the plurality of networked entity nodes comprises a respective identifier of each of the plurality of networked entity nodes, and wherein the information indicating the defined order in which the plurality of networked entity nodes is arranged comprises a respective ranking for each network entity node of the plurality of network entity nodes.

5. The computer-implemented method according to claim 1, further comprising:
at the dynamic data packet routing service further:
initializing a counter for a first temporal threshold of the set of temporal thresholds, the first temporal threshold for the first networked entity node of the plurality of networked entity nodes; and
storing to the memory a value of the counter.

6. The computer-implemented method according to claim 5, further comprising:
at the dynamic data packet routing service further:
receiving, from the first networked entity node, a response data packet, the response data packet indicating an approval by the first networked entity node; and
terminating the automated routing of the cascading data packet to any other networked entity node of the plurality of networked entity nodes based at least in part on the response data packet indicating the approval by the first networked entity node, wherein terminating the automated routing comprises disabling the counter.

7. The computer-implemented method according to claim 5, further comprising:
at the dynamic data packet routing service further:
receiving, from the first networked entity node, a response data packet, the response data packet indicating a rejection by the first networked entity node;
routing the cascading data packet to a second networked entity node of the plurality of networked entity nodes based at least in part on the response data packet indicating the rejection by the first networked entity node;
initializing a second counter for a second temporal threshold of the set of temporal thresholds based at least in part on the response data packet indicating the rejection by the first networked entity node, the second temporal threshold for the second networked entity node of the plurality of networked entity nodes; and
disabling the first counter for the first temporal threshold based at least in part on the response data packet indicating the rejection by the first networked entity node.

8. The computer-implemented method according to claim 5, further comprising:
at the dynamic data packet routing service further:
determining that the value of the counter has exceeded the first temporal threshold;
routing the cascading data packet to a second networked entity node of the plurality of networked entity nodes based at least in part on determining that the value of the counter has exceeded the first temporal threshold;
initializing a second counter for a second temporal threshold of the set of temporal thresholds based at least in part on determining that the value of the counter has exceeded the first temporal threshold, the second temporal threshold for the second networked entity node of the plurality of networked entity nodes; and
disabling the first counter for the first temporal threshold based at least in part on determining that the value of the counter has exceeded the first temporal threshold.

9. The computer-implemented method according to claim 1, further comprising:
at the dynamic data packet routing service further:
providing, to a user interface, one or more first user interface input elements, the one or more first user interface input elements editable to indicate two or more networked entity nodes, wherein the one or more inputs identifying the plurality of networked entity nodes arranged in the defined order comprises a first user input being applied to the one or more first user interface input elements.

10. The computer-implemented method according to claim 9, wherein receiving the routing sequencing parameters is based at least in part on the first user input being applied to the one or more first user interface input elements.

11. The computer-implemented method according to claim 1, further comprising:
at the dynamic data packet routing service further:
providing, to a user interface, one or more first user interface input elements, the one or more first user interface input elements editable to indicate one or more temporal thresholds, wherein the one or more temporal threshold parameters are received based at least in part on a first user input being applied to the one or more first user interface input elements.

12. A computer-program product comprising a non-transitory machine-readable storage medium storing computer instructions that, when executed by one or more processors, perform operations comprising:
at a dynamic data packet routing service:
receiving, via a network:
one or more inputs for constructing a cascading data packet;
one or more inputs identifying a plurality of networked entity nodes arranged in a defined order; and
one or more cascading parameters for generating dynamic routing instructions for dynamically routing the cascading data packet across a network of entity node accounts, wherein the one or more cascading parameters include (a) routing sequencing parameters and (b) one or more temporal threshold parameters;
configuring, by a microservice of the dynamic data packet routing service, the cascading data packet based on the one or more cascading parameters, wherein configuring the cascading data packet includes:
encoding for the cascading data packet a set of dynamic routing instructions that, when executed, causes an automated routing of the cascading data packet along one or more entity nodes of the plurality of networked entity nodes in an order predefined by the routing sequencing parameters;
encoding for the cascading data packet a set of temporal thresholds that sets a temporal limit for each instance of a routing of the cascading data packet to a respective entity node of the plurality of networked entity nodes based on the one or more temporal threshold parameters, wherein the temporal limit, when satisfied, causes an automatic re-routing of the cascading data packet from a current entity node of the plurality of networked entity nodes to a subsequent entity node of the plurality of networked entity nodes that follows the current entity node within the defined order;
storing to a memory the cascading data packet and the configuration of the cascading data packet; and
transmitting from the memory, via the network, the cascading data packet to a first networked entity node of the plurality of networked entity nodes in response to an input for launching the cascading data packet.

13. The computer-program product according to claim 12, performing operations further comprising:
at the dynamic data packet routing service further:
generating, based at least in part on the one or more inputs identifying the plurality of networked entity nodes arranged in the defined order, a data structure;
storing, in the data structure, information that indicates each networked entity node in the plurality of networked entity nodes and the defined order in which the plurality of networked entity nodes is arranged; and
providing, via the network, signaling indicating that the information has been successfully stored in the data structure.

14. The computer-program product according to claim 13, performing operations further comprising:
at the dynamic data packet routing service further:
receiving, via the network, an identifier for the data structure or one or more identifiers for the plurality of networked entity nodes;
comparing the received identifier for the data structure with a stored identifier of the data structure or the received one or more identifiers for the plurality of networked entity nodes with one or more stored identifiers of the plurality of networked entity nodes; and
selecting the data structure based at least in part on the comparing, wherein transmitting the cascading data packet is based at least in part on the selecting.

15. The computer-program product according to claim 13, wherein the information indicating each networked entity node in the plurality of networked entity nodes comprises a respective identifier of each of the plurality of networked entity nodes, and wherein the information indicating the defined order in which the plurality of networked entity nodes is arranged comprises a respective ranking for each network entity node of the plurality of network entity nodes.

16. The computer-program product according to claim 12, performing operations further comprising:
at the dynamic data packet routing service further:
initializing a counter for a first temporal threshold of the set of temporal thresholds, the first temporal threshold for the first networked entity node of the plurality of networked entity nodes; and
storing to the memory a value of the counter.

17. The computer-program product according to claim 12, performing operations further comprising:
at the dynamic data packet routing service further:
receiving, from the first networked entity node, a response data packet, the response data packet indicating an approval by the first networked entity node; and
terminating the automated routing of the cascading data packet to any other networked entity node of the plurality of networked entity nodes based at least in part on the response data packet indicating the approval by the first networked entity node, wherein terminating the automated routing comprises disabling the counter.

18. A computer-implemented system, comprising:
one or more processors;
a memory; and
a computer-readable medium operably coupled to the one or more processors, the computer-readable medium having computer-readable instructions stored thereon that, when executed by the one or more processors, cause a computing device to perform operations comprising:
receiving, via a network:
one or more inputs for constructing a cascading data packet;
one or more inputs identifying a plurality of networked entity nodes arranged in a defined order; and
one or more cascading parameters for generating dynamic routing instructions for dynamically routing the cascading data packet across a network of entity node accounts, wherein the one or more cascading parameters include (a) routing sequencing parameters and (b) one or more temporal threshold parameters;
configuring, by a microservice of the dynamic data packet routing service, the cascading data packet based on the one or more cascading parameters, wherein configuring the cascading data packet includes:
encoding for the cascading data packet a set of dynamic routing instructions that, when executed, causes an automated routing of the cascading data packet along one or more entity nodes of the plurality of networked entity nodes in an order predefined by the routing sequencing parameters;
encoding for the cascading data packet a set of temporal thresholds that sets a temporal limit for each instance of a routing of the cascading data packet to a respective entity node of the plurality of networked entity nodes based on the one or more temporal threshold parameters, wherein the temporal limit, when satisfied, causes an automatic re-routing of the cascading data packet from a current entity node of the plurality of networked entity nodes to a subsequent entity node of the plurality of networked entity nodes that follows the current entity node within the defined order;
storing to the memory the cascading data packet and the configuration of the cascading data packet; and
transmitting from the memory, via the network, the cascading data packet to a first networked entity node of the plurality of networked entity nodes in response to an input for launching the cascading data packet.

19. The computer-implemented system according to claim 18, the computer-readable instructions, when executed by the one or more processors, further causing the computing device to perform operations comprising:
at the dynamic data packet routing service further:
generating, based at least in part on the one or more inputs identifying the plurality of networked entity nodes arranged in the defined order, a data structure;
storing, in the data structure, information that indicates each networked entity node in the plurality of networked entity nodes and the defined order in which the plurality of networked entity nodes is arranged; and
providing, via the network, signaling indicating that the information has been successfully stored in the data structure.

20. The computer-implemented system according to claim 19, the computer-readable instructions, when executed by the one or more processors, further causing the computing device to perform operations comprising:
at the dynamic data packet routing service further:
receiving, via the network, an identifier for the data structure or one or more identifiers for the plurality of networked entity nodes;
comparing the received identifier for the data structure with a stored identifier of the data structure or the received one or more identifiers for the plurality of networked entity nodes with one or more stored identifiers of the plurality of networked entity nodes; and
selecting the data structure based at least in part on the comparing, wherein transmitting the cascading data packet is based at least in part on the selecting.
